(19) United States
(12) Patent Application Publication
(10) Pub. No.: US 2024/0218705 A1
(43) Pub. Date: Jul. 4, 2024

(54) PORTABLE LOCK OPERABLE IN OUTDOOR ENVIRONMENTS

(71) Applicant: ARTURO VALDES RUDD, PLANO, TX (US)

(72) Inventor: ARTURO VALDES RUDD, PLANO, TX (US)

(21) Appl. No.: 18/533,567

(22) Filed: Dec. 8, 2023

Related U.S. Application Data
(63) Continuation of application No. 18/377,759, filed on Oct. 6, 2023.
(60) Provisional application No. 63/414,285, filed on Oct. 7, 2022.

(51) Int. Cl. E05B 49/00; E05B 37/00

(52) U.S. Cl. CPC E05B 49/00; E05B 37/0068

(57) ABSTRACT

A novel portable padlock designed for operation in outdoor environments. The lock mechanism can be operated by built-in control electronics. The lock mechanism can be designed to be waterproof. The disclosed novel smart lock can communicate via GSM, Bluetooth and/or WIFI, with an easy-to-use web platform or app in order to control or operate various functions of the novel smart padlock. The integrated control electronics can additionally be equipped with a GPS that allows its traceability to be displayed. The padlock can include a built-in touch keyboard that allows the padlock to be opened with a passkey, in places where there is no cellular coverage and remote unlocking is not possible. The padlock can be opened via RFID card or GPRS, Wifi and/or Bluetooth signal, using a web application or app. The padlock can also include one or more integrated sensors to provide information concerning the opening, closing and cutting events for the padlock.

This application is a continuation of U.S. application Ser. No. 18/377,759, filed Oct. 6, 2023, which claims the benefit of and priority to U.S. Application Ser. No. 63/414,285, filed Oct. 7, 2022. All of the above applications are incorporated by reference in their entireties for all purposes.

### 1. FIELD OF THE DISCLOSURE

The disclosure relates generally to locks and more specifically to a padlock operable in outdoor environments.

### 2. BACKGROUND

Currently, portable padlocks that can be opened by means of control electronics, activated through a keyboard or through Bluetooth or RF communication from a smartphone, typically lack connectivity to a cell phone network to use them in mobile solutions that require traceability through GPS or through intelligent platforms such as ALEXA, Google Assistant, SIRI, etc. that can be managed remotely. The novel portable lock disclosed herein is directed to overcoming or reducing one or more problems associated with currently available portable padlocks.

### SUMMARY OF THE DISCLOSURE

Generally disclosed is a novel portable lock/CP3 padlock that can be designed for operation in outdoor environments. The novel padlock can be provided with a custom-made lock mechanism preferably operated by built-in control electronics. The lock mechanism can be designed to be waterproof, and the manufacturing process for the lock allows for mass production of the novel locks.

The disclosed novel smart lock can communicate via GSM, Bluetooth and/or WIFI, (though not limiting and other wireless communication technologies now known or later developed can also be used for communication) with an easy-to-use web platform or app in order to control or operate various functions of the novel smart padlock. The integrated control electronics can additionally be equipped with a GPS that allows its traceability to be displayed. Certain non-limiting characteristics of the disclosed novel padlock can include:
a. can be provided with a built-in touch keyboard that allows the padlock to be opened with a passkey, in places where there is no cellular coverage and remote unlocking is not possible.
b. can be opened via RFID card or GPRS, Wifi and/or Bluetooth signal, using a web application or app.
c. can operate with rechargeable batteries, which are preferably recharged using a provided solar panel(s), such that the batteries preferably do not have to be removed for recharging;
d. easy installation and removal;
e. waterproof, with preferably IP-67 standard to accommodate the electronics;
f. can be made of a light and high hardness metal alloy; and.
g. real-time opening alerts and handling notifications.
   Other non-limiting, non-exclusive, novel features, advantages, functions and/or benefits of the portable padlock disclosed herein, include:
a. a novel lock design that facilitates its electronic opening and which can have a level of protection against external elements such as water;
b. can include integrated sensors in its design, that provide knowledge and information, such as, without limitation, whether they were opened or closed, cut, etc;
c. can use of a solar panel that allows the use of the lock's electronics without the need to frequently recharge it (i.e. a battery for the electronics);
d. can include an associated APP specially designed to manage various functionalities of the lock via connectivity through, one or more of the following, non-limiting, examples:
i. GPRS (cell phone connectivity oriented to data transmission);
ii. WIFI connectivity that allows you to communicate with artificial intelligence platforms such as ALEXA, Google Assistant or SIRI; and/or
iii. Bluetooth connectivity.

Additionally, managing the novel portable lock remotely through use of the associated APP can also provide the following non-limiting benefits:
i. remote opening of the novel portable lock anywhere with internet connectivity.
ii. real-time notifications of alarms emitted by the padlock's sensors, such as, without limitation, unauthorized opening attempts, which allows the authorities to save time, in addition to knowing the precise location of where the alarm is occurring.
iii. can provide historical files of the behavior of the padlock, such as the date and time they were opened or closed
iv. a physical key is not necessary to open the novel portable padlock; and/or
v. it is not necessary to remove any battery needed for the electronics for recharging, as they can be recharged through use of a provided solar panel(s).

### BRIEF DESCRIPTION OF THE DRAWINGS

FIG. 1 is an exploded view of a first embodiment for the novel portable padlock for the non-limiting use with a continuity cable/shackle in accordance with the present disclosure;

FIG. 1A is an exploded view of another embodiment for the novel portable padlock for the non-limiting use with a cable wire rope in accordance with the present disclosure;

FIGS. 2A, 2B and 2C are perspective views illustrating the shackle component in different positions (represent in the novel portable padlock in an open or closed (i.e. locked) position in accordance with the present disclosure;

FIGS. 3A and 3B are perspective views showing the interaction between the shackle and button in accordance with the present disclosure;

FIGS. 4A, 4B, 4C and 4D are partial sectional views showing the locking mechanism in accordance with the present disclosure;

FIGS. 5A, 5B, 5C and 5D are perspective views illustrating a non-limiting assembly process for the latch spring of the novel portable padlock in accordance with the present disclosure;

FIGS. 6A and 6B are perspective views of the shackle and illustrate the non-limiting slanted contact surfaces in accordance with the present disclosure;

FIGS. 7A and 7B are views illustrating the shackle in a locked position in accordance with the present disclosure;

FIGS. 8A and 8B are perspective views of the top/front portion or cover of the padlock housing or body member showing additional blockage for the top in accordance with the present disclosure;

FIGS. 9A, 9B, 9C, 9D and 9E are view showing the interaction between the solenoid and latch housing in accordance with the present disclosure;

FIGS. 10A, 10B, 10C and 10D illustrate partial sectional views showing the unlocking mechanism in accordance with the present disclosure;

FIGS. 11A and 11B illustrate the interaction between the shackle base and the shackle base cover in accordance with the present disclosure;

FIGS. 12A and 12B illustrate the interaction between the shackle base and the shackle lock in accordance with the present disclosure;

FIGS. 13A and 13B illustrate the interaction between the shackle opening or cutting sensor and the one or more switches preferably placed on the body box/housing in accordance with the present disclosure;

FIGS. 14, 15, 16 and 17 illustrate a first, non-limiting, embodiment for the padlock body box/housing (minus the top or front portion or cover) in accordance with the present disclosure;

FIGS. 18 and 19 illustrate another embodiment for the padlock body box/housing (minus the top or front portion or cover) in accordance with the present disclosure;

FIG. 20 illustrates a bottom perspective view of the top or front portion or cover of padlock body box/housing in accordance with the present disclosure;

FIG. 21 illustrates a top perspective view of the top or front portion or cover of FIG. 20;

FIGS. 22, 23, 24 and 25 illustrate several views of the shackle base in accordance with the present disclosure;

FIGS. 26 and 27 illustrate view of the shackle base cover in accordance with the present disclosure;

FIGS. 28, 29, 30 and 31 illustrate the shackle component/part in accordance with the present disclosure;

FIGS. 32, 33, 34 and 35 illustrate several views of the shackle lock in accordance with the present disclosure;

FIG. 36 is a perspective view of a sealing nut in accordance with the present disclosure;

FIGS. 37, 38 and 39 illustrate several views of the latch housing in accordance with the present disclosure;

FIG. 40 is a perspective view of a latch housing set screw in accordance with the present disclosure;

FIGS. 41 and 42 illustrate a first or left latch in accordance with the present disclosure;

FIGS. 43 and 44 illustrate a second or right latch in accordance with the present disclosure;

FIGS. 45 and 46 are perspective view of a cable wire rope in accordance with the present disclosure;

FIGS. 47 and 48 illustrate a first or left fitting accessory in accordance with the present disclosure;

FIGS. 49, 50 and 51 illustrate a non-limiting embodiment for the button in accordance with the present disclosure; and

FIGS. 52 and 53 illustrate a non-limiting embodiment for the shackle opening and cutting sensor in accordance with the present disclosure.

### DETAILED DESCRIPTION

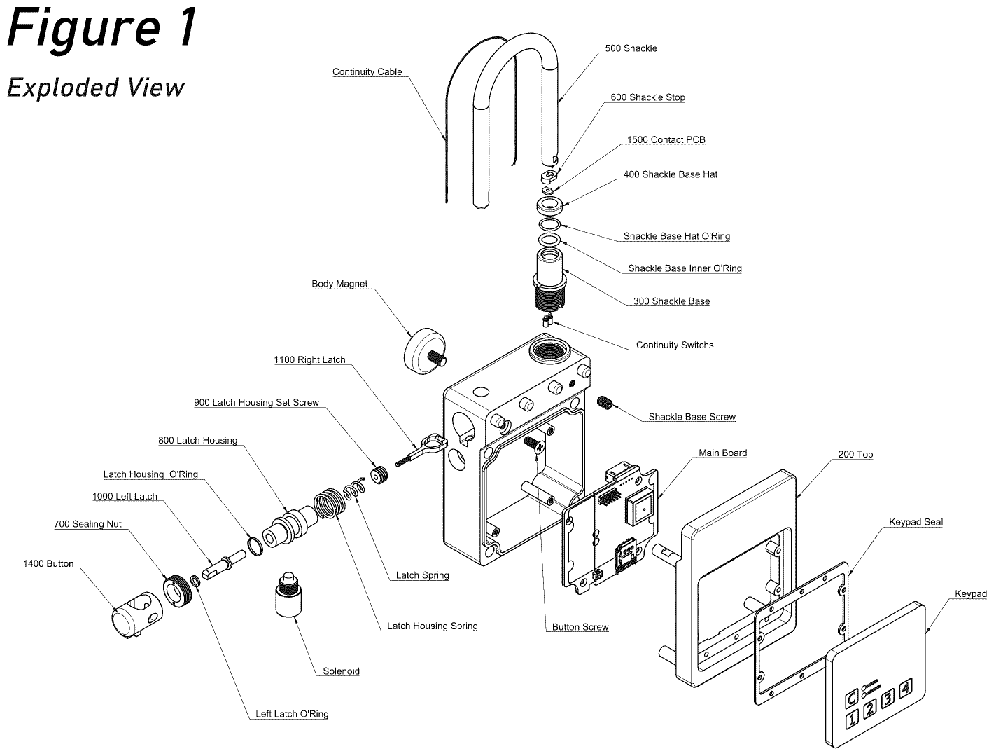

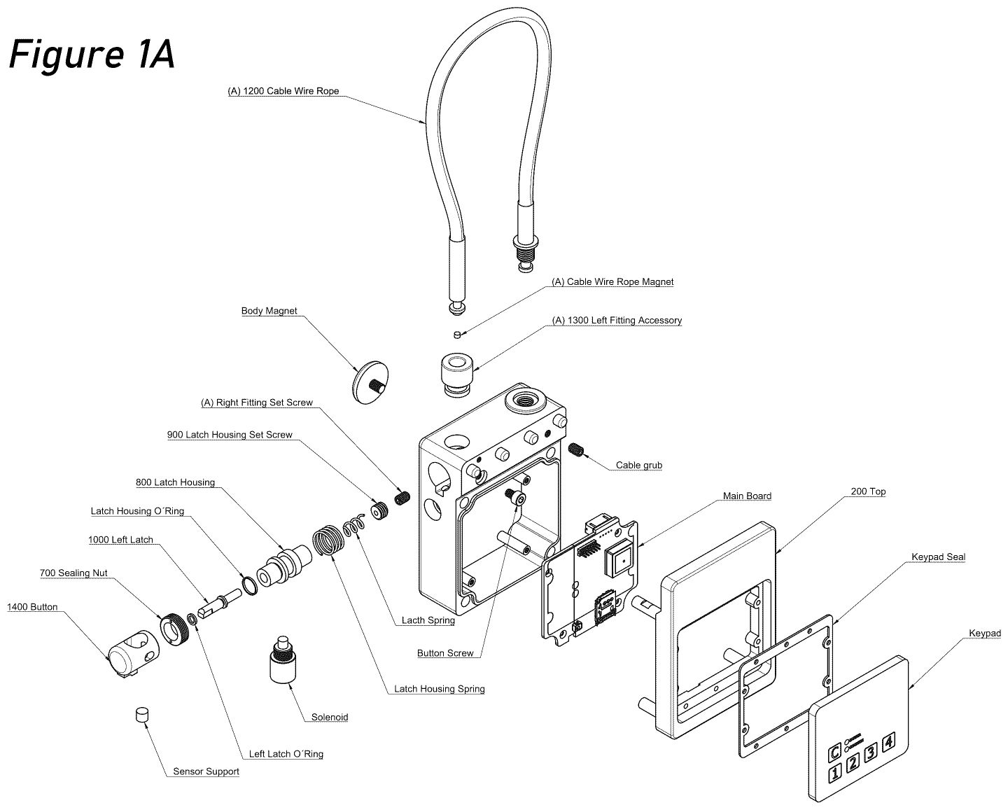

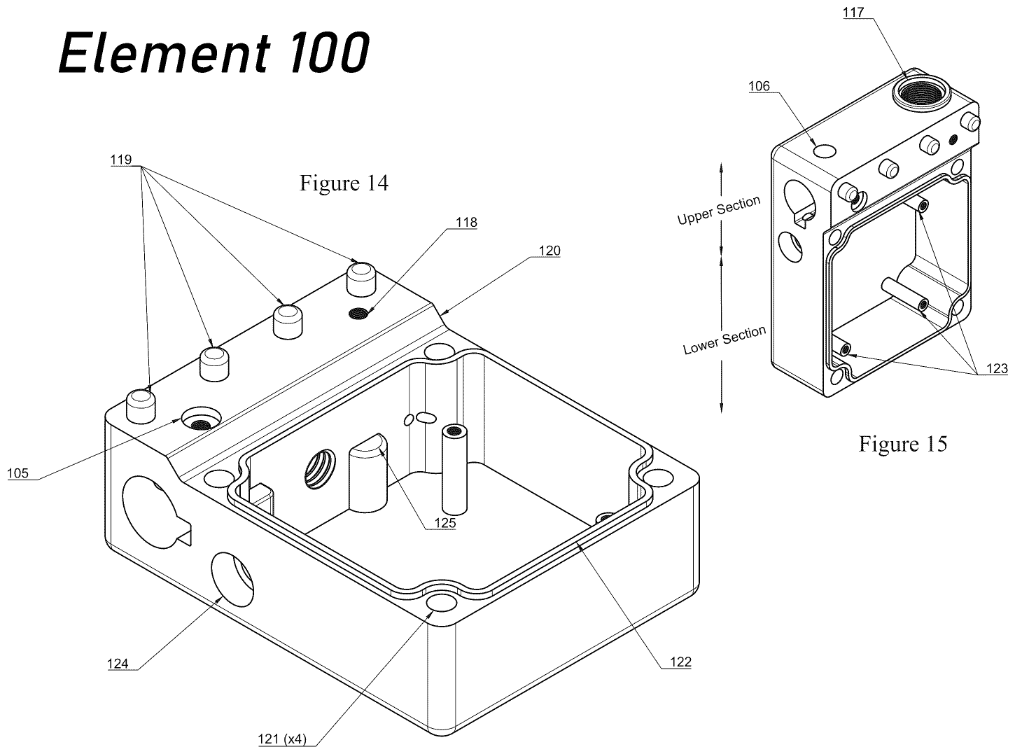

FIG. 1 is a first embodiment for the novel portable padlock, shown in exploded view (so that the non-limiting preferred parts/components can be seen). In this non-limiting embodiment, the padlock can include a body 100 (see FIGS. 14-17), with portions of body 100 discussed below using reference numerals 101 to 125. Though not limiting, body 100 can be rectangular shaped and houses most of the parts that make up the padlock. In one non-limiting embodiment, body 100 can be constructed or manufactured from an aluminum-alloy monobloc part, preferably manufactured by an injection molding process. However, other materials and manufacturing techniques/processes can be used and are considered within the scope of the invention. For purposes of describing the function of body 100, body 100 will be divided or described into two separate sections/areas (i.e. upper and lower, etc.):

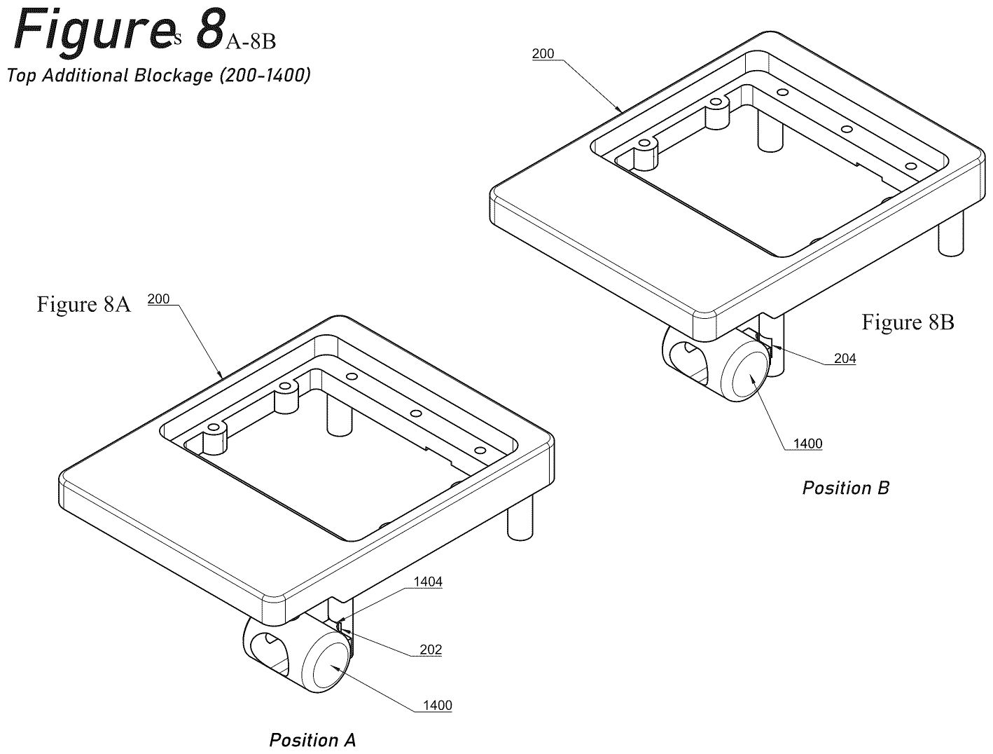

Upper section of body 100: Though not limiting, this section/area can occupy approximately one third of the total volume of the case/body. The upper section can house the parts that make up the lock mechanism. Perforation/opening/passageway (“Opening”) 101 can be the largest in diameter as compared to the other openings/perforations. Opening 101 can house and/or receive the button 1400 (see FIG. 1 and FIGS. 49-51). Opening 101 can be provided with a channel (102) (preferably rectangular in shape—though not limiting) that can run from the outside to about half of the cylindrical section. The preferred rectangular-shaped part 1404 of button 1400 can move through this channel. Towards the middle of the channel there is a hole 103 can be provided which can allow the entry of one of the anchoring posts 201 of the top/front cover/side member 200 (See FIG. 1 and FIGS. 20-21). Preferably, the position of channel 102 relative to opening 103 makes it possible for the shallow slot 202 of anchoring post 201 to align with part 1404 of button 1400, where the latter performs the function of a latch, providing additional securement of top 200. (See FIGS. 8A-8B)

At the end of the channel (102) there is a cylindrical hole can be provided which can house the sensor support. The sensor support can interact with a Shackle Magnet placed on the left end 505 of the shackle 500 (See FIG. 14). A Within opening 101 a threaded hole (105) (FIG. 14) can be provided and can be preferably in a perpendicular position to the section's axis, for securement or receipt of a Button Screw to secure Button 1400 so that it preferably cannot be removed from Body 100. Across from 104, a hole 106 can be provided for receipt of left end 505 of shackle 500. Thus left end 505 of shackle 500 enters the novel portable padlock through hole 106. A conduit for the magnetic sensor cable can also be provided and can be housed in the sensor bracket, to enter the space where the lock control electronics can be preferably located.

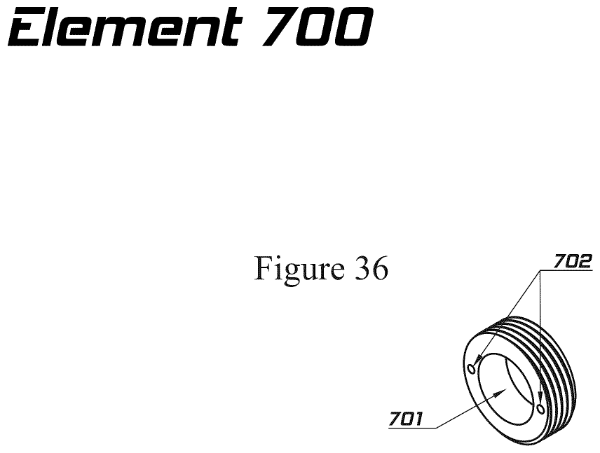

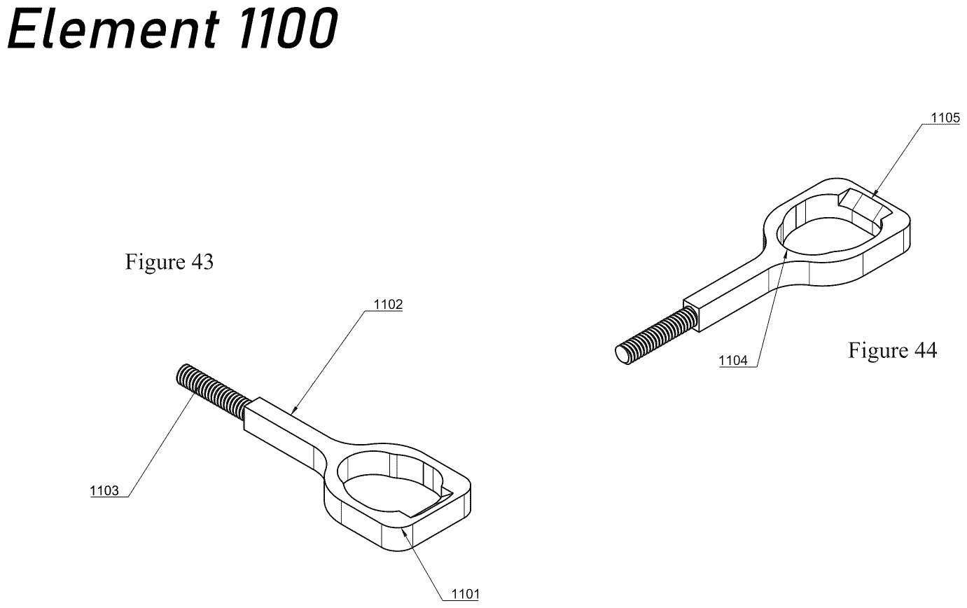

A portion/section 108 (see FIG. 16) can be threaded to match the Sealing Nut (700) (FIG. 36) that can be provided to divide the next cylindrical section (109) preventing the elements contained within latch housing 800 from being able to come out. A threaded hole 110 preferably disposed perpendicular to section 109 can be provided for securement/receipt of a solenoid. At the end of section 109, the cavity can be closed by a circular wall 111. A center area of wall 111 can be provided with a hole 115, which can be rectangular in shape (though not limiting). A right latch 1100 (FIGS. 43 and 44), can slide through hole 115.

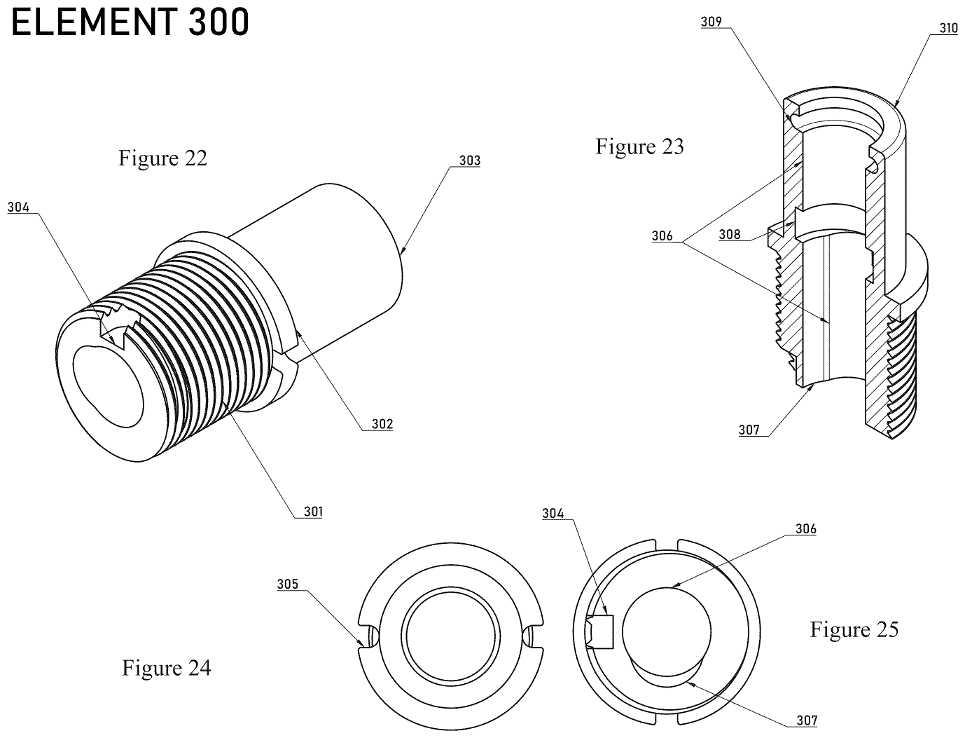

A preferably threaded cavity 112 can be provided for setting/securement and receipt of a Shackle Base 300 (see FIGS. 22-25). Portion 117 can provide additional reinforcement to this joint. Shackle base 300 can be secured in place with the Shackle Base Screw which can be inserted or placed in hole 118. As best seen in FIGS. 16 and 17, adjacent or around this area of body 100 three additional perforations/holes: 113, 114 and 116 can be provided. Holes 113 and 114 can be aligned with hole 112 and can be provided to house shackle stop/lock 600 when shackle 500 is in its closed/locked position. Holes 116 (which can be two holes) can house two switches connected by cables that enter the interior chamber of the body 100, where the electronics are housed.

In addition to the described perforations/openings/holes, the upper section can be provided with two features/parts that can provide greater rigidity to the joining of Body 100 with Top 200, and which can be designated as reinforcements 119 and 120. Reinforcement 119 can comprise one or more posts, and in a non-limiting preferred embodiment can comprise four solid posts, which enter corresponding holes 203 in Top 200. Reinforcement 120 provides a step or ledge (which can be angled) across the width of Body 100 and can match/correspond to the shape of step/ledge 204 on Top 200. This reinforced assembly can provide relief to the padlock (i.e. effective) against the blows that the padlock may receive from its bottom upwards.

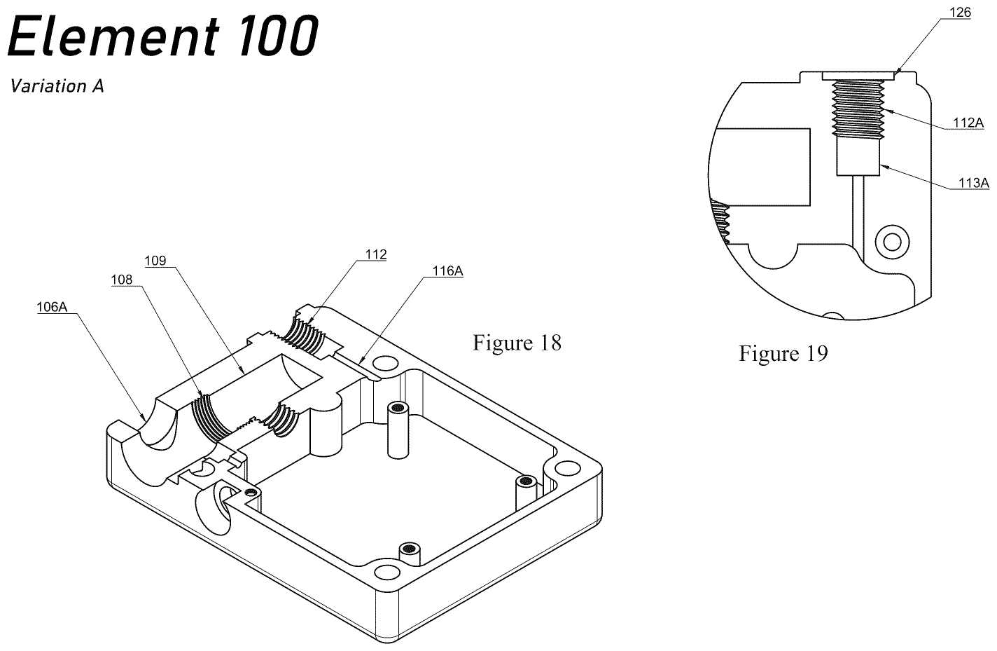

Lower section of body 100: An area (which can be square or rectangular in shape—though not considered limiting that serves as the primary portion of body 100 for joining body 100 with top 200. One or more anchoring posts 201 (and preferably four anchoring posts—though not limiting) (see FIG. 20) can be provided and can be screwed from the bottom of the holes 121 (See FIG. 14) and can house the electronic components. Lower section perimeter protrusion/frame 122 can protrude outward from body 100 and fits into (i.e. is received) cavity 205 (preferably similar in shape to perimeter protrusion 122) of Top 200 can press a Top Seal. The Printed Circuit Board can be fixed upon the one or more inner posts 123 (See FIG. 15), which can be four inner posts 123 (though not limiting to four posts), and which can double as limitations for the Battery.

The battery charger socket can be placed on the hole 124. The non-limiting, half-cylinder-shaped projection 125 (See FIG. 14) that protrudes inside the box 100 within the lower section and can allow a threaded hole to be opened on the outside of body 100, with the purpose of housing a screw that can be provided for securing the external Magnet.

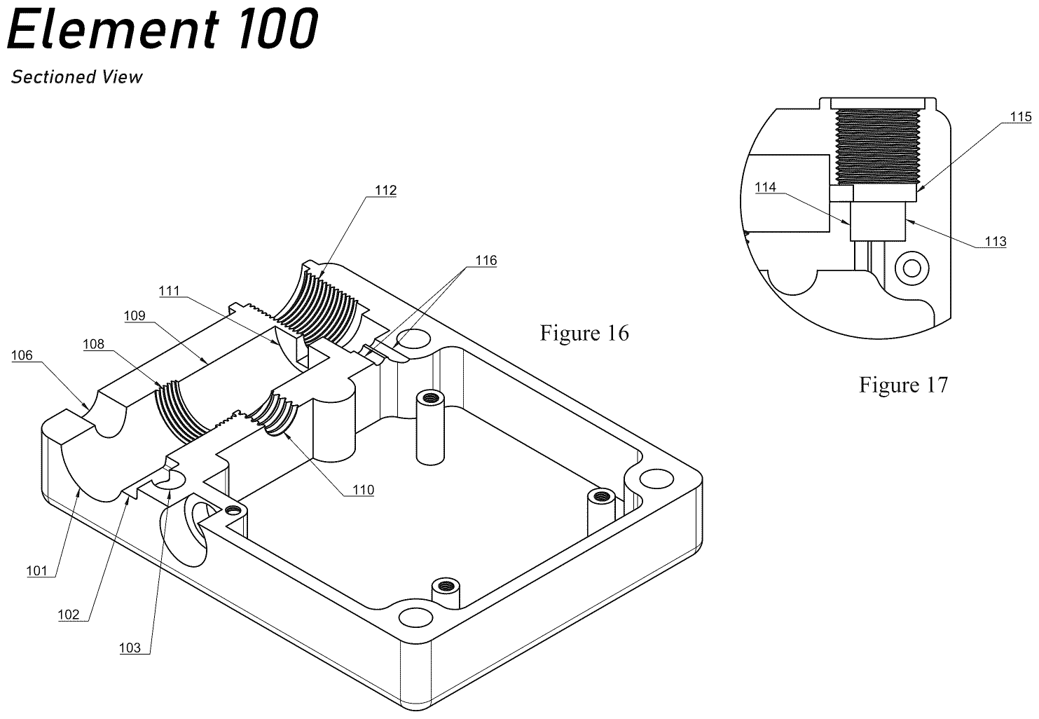

FIG. 1A illustrate an alternative embodiment for the body and is designated as body 100A. As will be apparent from a comparison of body 100 to body 100A many of the sections/parts/portions are the same or highly similar and the above or below discussion of the same or highly similar parts in connection with one embodiment is considered to also apply to be in connection with the other embodiment. In this alternative non-limiting embodiment, the padlock can include a body 100A (see FIGS. 18-19), with portions of body 100A discussed below using reference numerals 101 to 126.

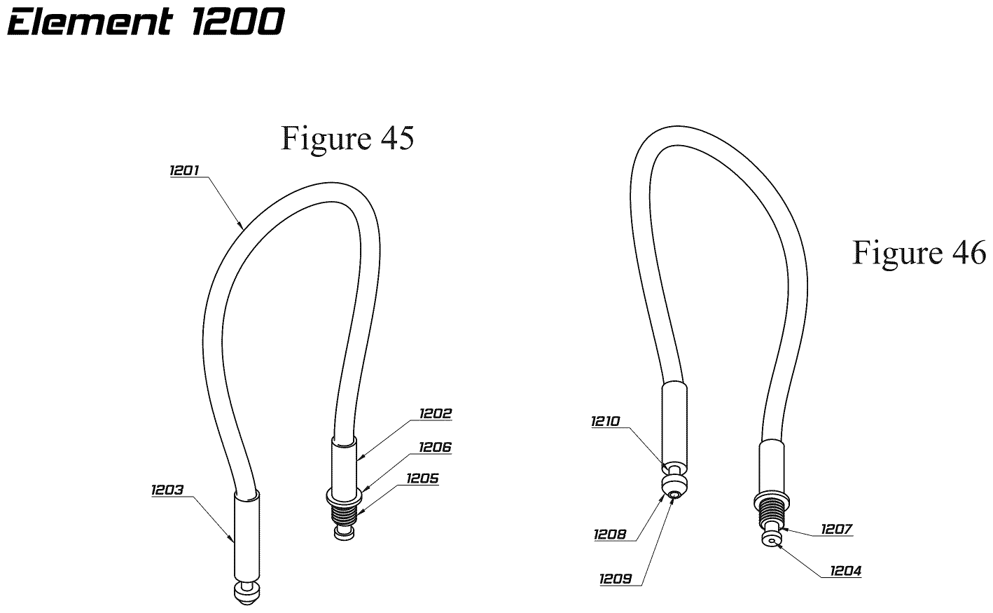

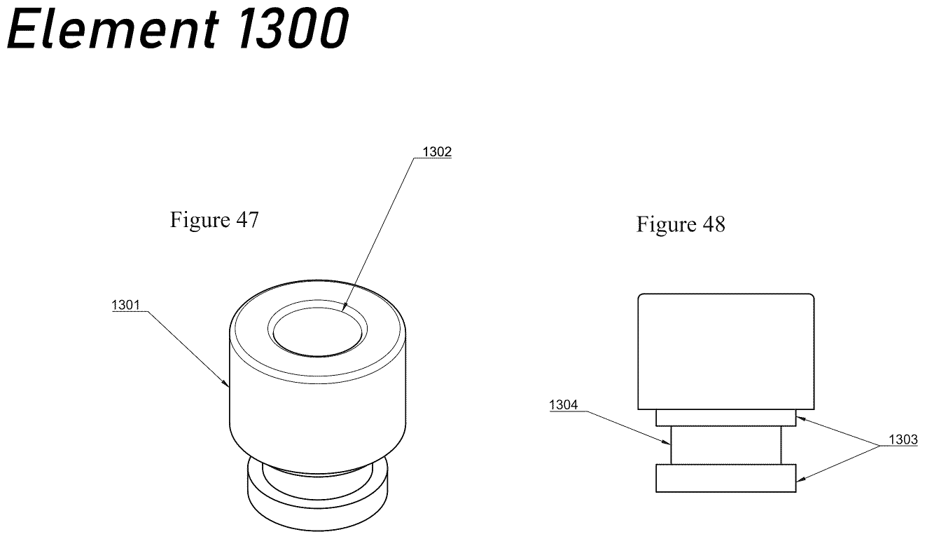

Though not considered limiting, the primary differences between body 100 and body 100A are:
a. Instead hole 106 located across from hole 104 (body 100), body 100A is provided with hole/opening 106A, which can be wider in diameter than hole 106, to house a Left Fitting Accessory 1300 (See FIGS. 47 and 48). Instead of receiving a left or first end of shackle 500 (as hole 106 received), hole 106A can allow or permit the entry of a left or first end of Cable Wire Rope 1200 (See FIGS. 45-46).
b. Threaded cavity 112A of body 100A can be smaller in diameter as compared to cavity 112 of body 100 and can receive a right or second end Cable Wire Rope 1200 the right/second end can be set to be screwed.
c Perforations 113 and 114 of body 100 can be merged into one perforation 112A (See FIG. 19) and aligned with hole 112A and can house the tip of right or second end of Cable Wire Rope 1200.
d. Deeper into feature/opening 117, hole 126 can be provided to allow flange 1206 of Cable Wire Rope 1200 to enter further into Body 100A.

Excluding the above differences, all of the above and below features, uses, parts, sections, etc. discussed for body 100 is also considered to apply to body 100A and is incorporated by referenced into the discussion of body 100A (even if not seen in FIGS. 18-19).

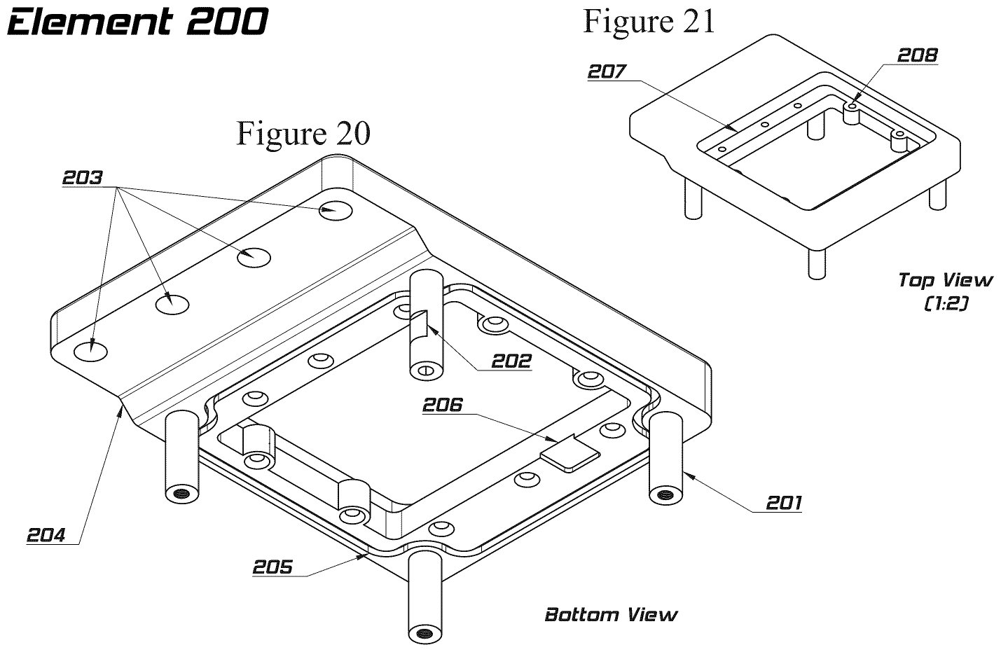

Top 200 is best seen in FIGS. 20 and 21, where portions thereof are called out by reference numbers 201 to 208. Preferably, though not limiting, having the same or virtually the same proportions in width and length as body 100 or body 100A, top 200 can cover and seal the opening defined in body 100 or 100A. Preferably, top 200 can be provided with 4 anchoring posts 201 with a threaded hole on the bottom (preferably of each post). Post 201 can be sized to fit into the holes 121 of the Body 100 or 100A, where screws can be provided to secure both parts together (though other securement mechanisms and techniques can also be used and are considered within the scope of the disclosure). In an upper portion of one of the post, such as, but not limited to, the upper left post a shallow slot 202 can be provided for allowing part/portion 1404 of button 1400 to act as a shaft, further securing top 200 to the rest of the novel padlock (See FIG. 8A).

Top 200 can be provided with a plurality of holes 203, such as, but not limited to four holes 203 where the 4 reinforcements 119 of body 100 or 100A can enter, for increasing the structural rigidity of the novel portable padlock with the union between both parts (bod 100/100A and top 200). With the same purpose of improving the structural resistance of the padlock, top 200 can be provided with a step/ledge 204 (preferably angled) that engages in step/ledge 120 presented in the body 100/100A when top 200 is properly secured to body 100/100A.

A cavity 205 can be provided on the bottom of top 200, which can be disposed all along the inner square hole that houses the Top Seal and allows for the frame/protrusion 122 of body 100 or 100A to exert pressure on this element. A cavity 206, preferably small cavity can be provided and used for where the actuator of a switch fits, generating an alert upon separation of top 200 from body 100 or 100A. A hollowed surface 207 on top 200 can be provided housing the padlock Keypad. A plurality of holes 208 (i.e. 10 holes, though non-limiting), can be provided in the keypad receiving area which are provided for fixing or securing the keypad with screws.

Shackle base 300 is best seen in FIGS. 22 and 23, where portions thereof are called out by reference numbers 301 to 310. Shackle base 300 can be a preferably cylindrical-shaped piece that can anchor shackle 500 to body 100 of the novel portable padlock (100), allowing the closing arch freedom of movement that facilitates the opening or closing of the padlock.

The exterior of shackle base 300 can be made up of three cylindrical bodies:
a. A base having a threaded exterior surface 301 to allow shackle base 300 to be screwed into hole 112 of the padlock box/body 100, remaining anchored in that position as a support for shackle 500. The lower part (i.e. outer end) of threaded surface 310 can have a hole 304 where a grub screw enters that locks the piece in a certain position so that it cannot be unscrewed. The grub screw is screwed into the body 100 through hole 118, in a position perpendicular to the closing arch support, locking it so that it cannot be unscrewed from the outside.
b. A cylinder 302 having a larger diameter than the base cylinder, and located approximately in the center of the shackle base 300. Cylinder 302 can act as a reinforcement to improve the support of the shackle base 300 in the body 100 of the padlock and also can serve as a stop that limits how the shackle base 300 can be screwed in at hole 112, inside body 100. Cylindrical member/cylinder 302 can have two parallel corners 305 on each side (see FIG. 24), to facilitate the use of a tool that allows the support base to be screwed into body 100.
c. An upper cylinder (303) having a height which can be limited by the stroke that shackle 500 makes to its opening position, providing it in that position with the support it requires to remain anchored. The upper (i.e. outer) end can interact with a ring that forms a shackle base cover for the purpose of waterproofing the central hole of the piece.

As seen in FIGS. 23 and 25, in its center, the support base can have a cylindrical hole/passageway 306 that can cross the piece, and hole 306 can have a diameter that allows the movement of a left or first leg of shackle 500, which moves inside the support base. Shackle 500 can make a rectilinear movement inside hole/passageway in two directions: (i) from bottom to top when the padlock is opened or (ii) in the opposite direction when it is closed.

From the bottom (outer end) of the support base until it meets the roughing that forms element 308, running parallel to hole 306, a crescent-shaped hole 307 can be provided. Hole 307 allows a stop 600 that can be welded or otherwise secured to the tip of shackle 500 to move inside shackle base 300.

Where elongated hole 307 ends (i.e. internal end), a blank/cutout 308 can be provided that preferably has a larger diameter than central hole 306. The preferred larger diameter of blank 308 can allow a shackle stop 600 to be housed inside, and which can be preferably trapped inside when it finishes its travels/stroke through hole 307. A stub can serves as a stop for shackle 500 so that it does not come out of support base 300 when it moves to its open position. This cylindrical roughing allows such when shackle 500 is in the open position, allow relevant portion of shackle 500 to be rotated in order to separate its left tip from body 100 of the padlock, thus facilitating the removal or placement of the padlock. The rotation of the relevant portion of shackle 500 in the open position within the roughing 308 can be a 360 degrees rotation.

In the upper part 303 near the top of shackle base 300, another blank/cutout 309 can be provided inside the central opening. Cutout 309 can have a cylindrical shape and have a diameter larger than the diameter hole 306, which is intended to house an O-ring that can allow for the seal of preferably the entire internal cylindrical cavity of the shackle base 300.

A first O-ring can be provided inside the support base of the closing arch: The first O-ring can be located in the cylindrical blank 309. The diameter of a central hole of the first O-ring can allow shackle 500 to slide. The first O-ring can interact with element shackle base hat/cover, for the purpose of sealing the entry of water into the compartment where the electronics are housed.

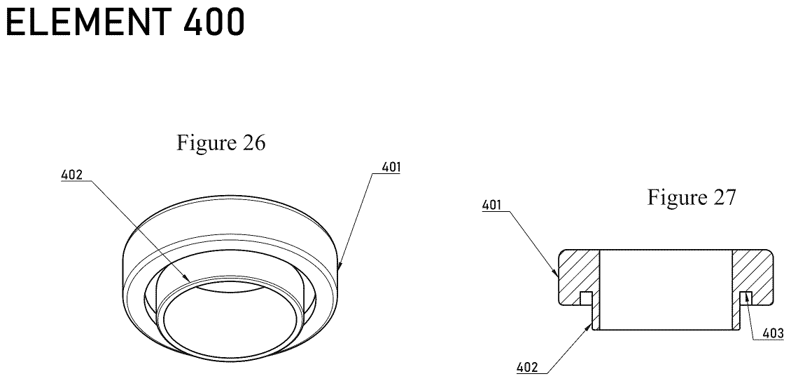

Shackle base cover 400 is best seen in FIGS. 26 and 27, where portions thereof are called out by reference numbers 401 to 403. Shackle base cover 400 can be a cylindrical piece that can be welded or otherwise secured to shackle 500. Its exterior shape can have two diameters. The portion 401 having the largest diameter covers the upper hole of shackle base 300, when shackle 500 is in the closed position, protecting the o-ring that is housed in internal cavity 309 of shackle base 300. Additionally, a slot 403 can be provided in the bottom of portion 410 for housing a second O-ring which is pressed against the upper wall 310 of shackle base 300 (when the padlock is in the closed position), helping to seal central hole 306.

The smaller diameter cylinder/portion 402 enters the center of the first O-ring housed in cavity 309 of shackle base 300, and similar to the second O-ring discussed in the previous paragraph, When shackle 500 is in its closed position, it complements the sealing of shackle base 300. This is achieved by pressing the cylinder to the first O-ring in its central diameter and consequently expanding it within cavity 309, to seal the internal hole 306 of shackle base 300 from the entry of water or other elements.

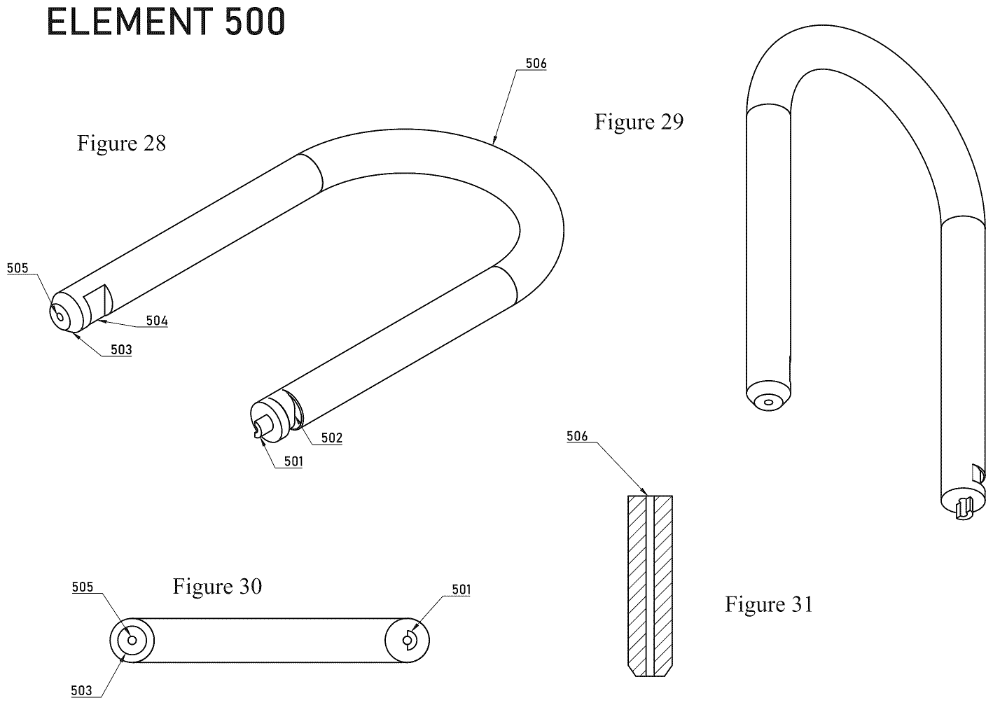

Shackle 500 is best seen in FIGS. 28 through 31, where portions thereof are called out by reference numbers 501 to 506. In a preferred, but non-limiting embodiment, shackle 500 can be generally a “U” shaped cylindrical tube 506, preferably provide with machined functional parts at both ends. The tip of the shackle's left or first end, which moves within shackle base 300, can be provided with a semicircular, preferably centered, figure or protrusion 501. In a preferred, but non-limiting embodiment, protrusion 501 can generally have half-moon shape, which passes through a central hole in shackle lock 600 and fixing it in a determined/predetermined position. Further along the left or first side/leg of the U′ shaped tube, a groove 502 can be provided which is where the right latch 1100 of the lock mechanism penetrates, blocking shackle 500 at that end, so that it cannot move when the padlock is closed (i.e. closed or locked position).

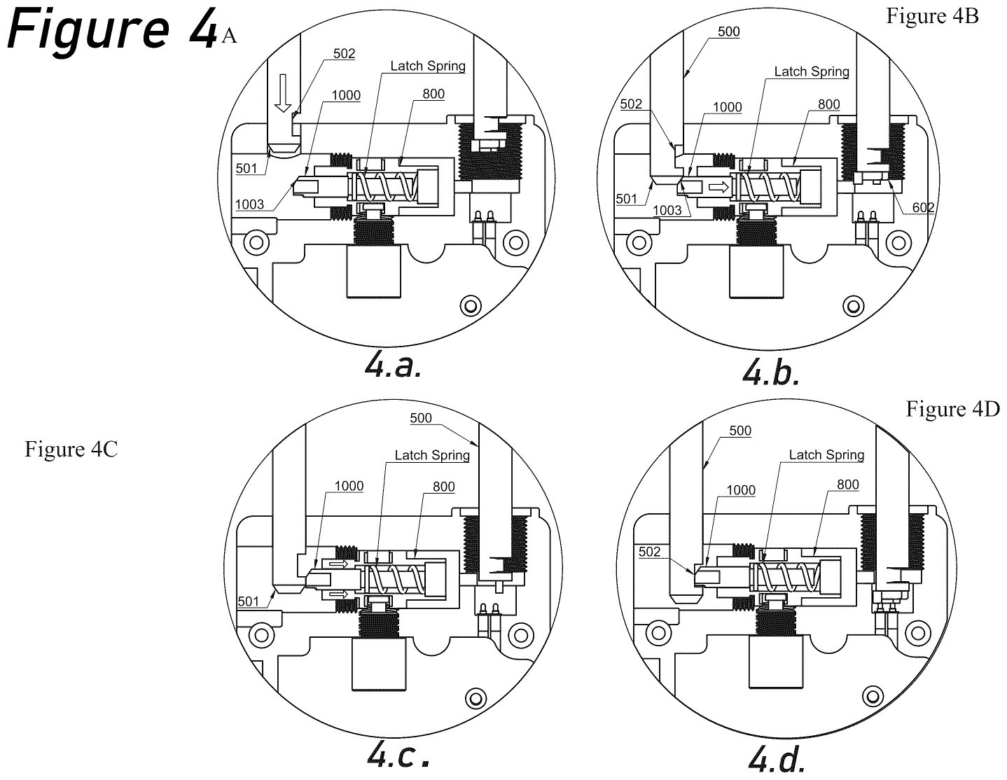

At the right or second tip of shackle 500, a conical groove/ledge 503 along the entire circumference can be provided and provides a certain angle for interacting with an angle of similar inclination for a groove/ledge 1003, present at the tip of left latch 1000 of the lock mechanism, with the function of moving the latch towards the interior of a cylinder 800 that houses it, in a movement perpendicular to the movement of shackle 500, when it is being pushed inside body 100 of the padlock towards its closed/locked position (See FIGS. 4A-4D).

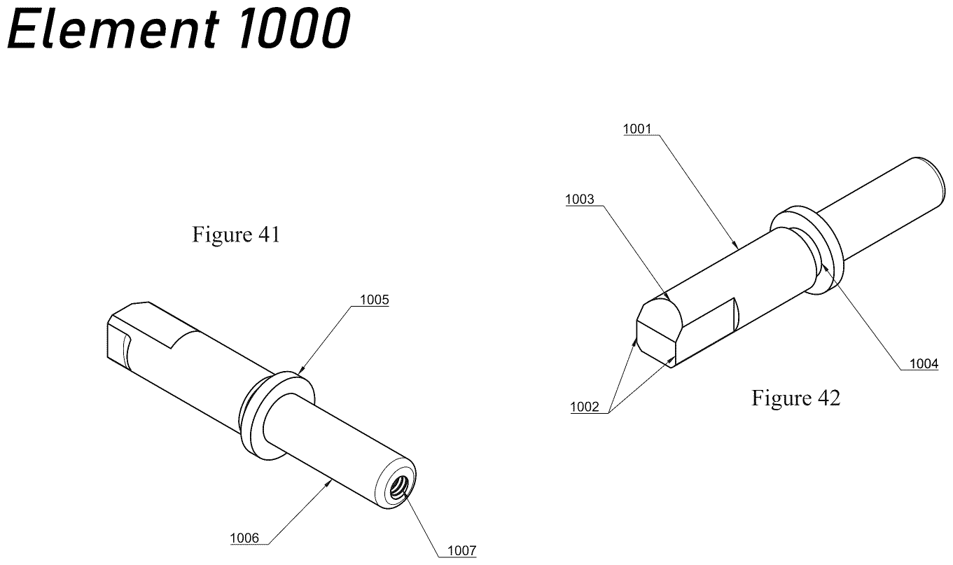

Above the conical-shaped tip, a slot 504 can be provided (See FIG. 28)(or 502 in FIGS. 4A-4D) where a tip 1001 of the left latch 1001 (See FIG. 41) enters, blocking shackle 500 on that side so that it cannot come out of the inside of the padlock body, when the padlock is in a closed/locked position/configuration.

A hole 505 can be provided at the tip of left/first side/leg of shackle 500 and a magnet can be housed therein that interacts with a magnetic sensor placed in body 100, with the purpose of registering the openings and closings of the padlock, by opening or closing the closing arc.

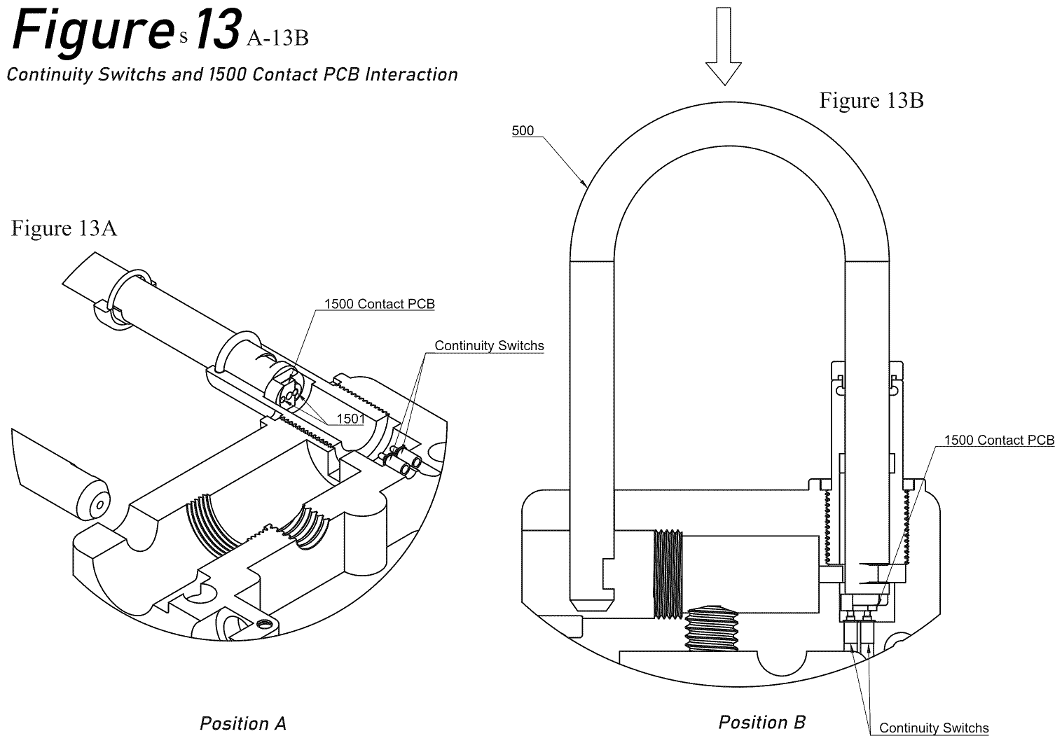

Inside U-shaped tube 506 a cable (See FIG. 1) can run the entire length of tube 506 and can connect to the opening and cutting sensor 1500. If the closing arc is cut, the cable inside is thus also cut, causing it to emit a loss of continuity signal, as sensor element 1500 is connected to the padlock control electronics (See FIGS. 13A and 13B).

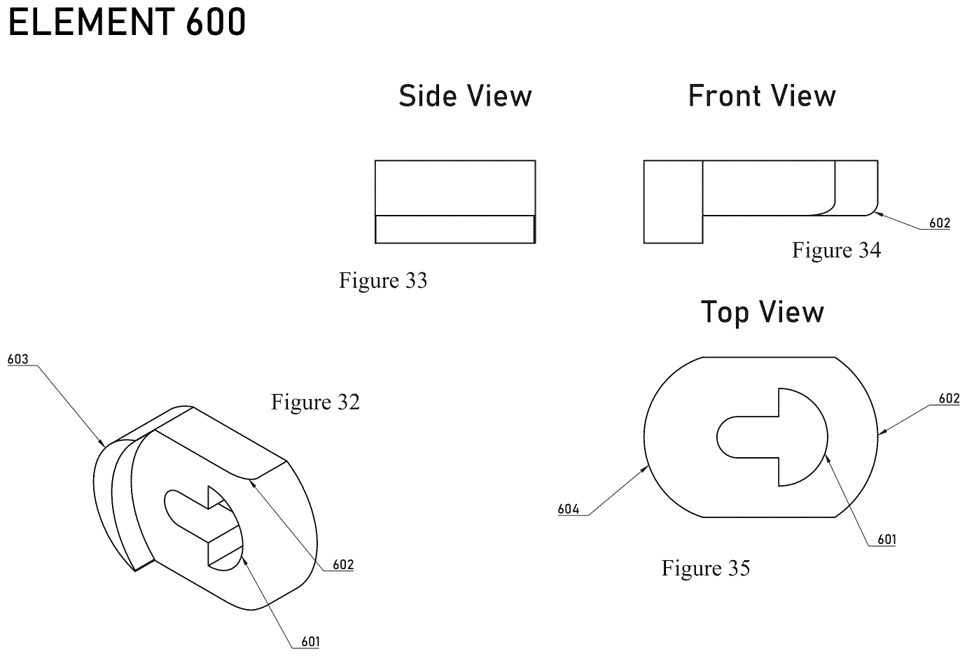

Shackle lock 600 is best seen in FIGS. 32 through 35, where portions thereof are called out by reference numbers 601 to 603. Though not limiting, shackle lock 600 can be a steel plate with a rectangular shape where its two smaller sides can have a semicircular or rounded shape. A center area of shackle lock 600 can be provided with a hole 60, which can be preferably crescent-shaped), for receipt of semi-cylindrical tip 501 of shackle 500. One purpose of this coupling can be to fix the steel plate shackle lock 600 in a certain position, and preferably welding it once properly positioned to shackle 500.

The left or first semicircular side on its upper edge 602, can have a semi-cylindrical rounding, for interacting with an angle portion 1105 of the right latch 1100 of the lock mechanism, allowing the movement of the right latch 1100 in a transverse direction to the direction in which shackle 500 moves when it is moving towards a closed/locked position inside the padlock.

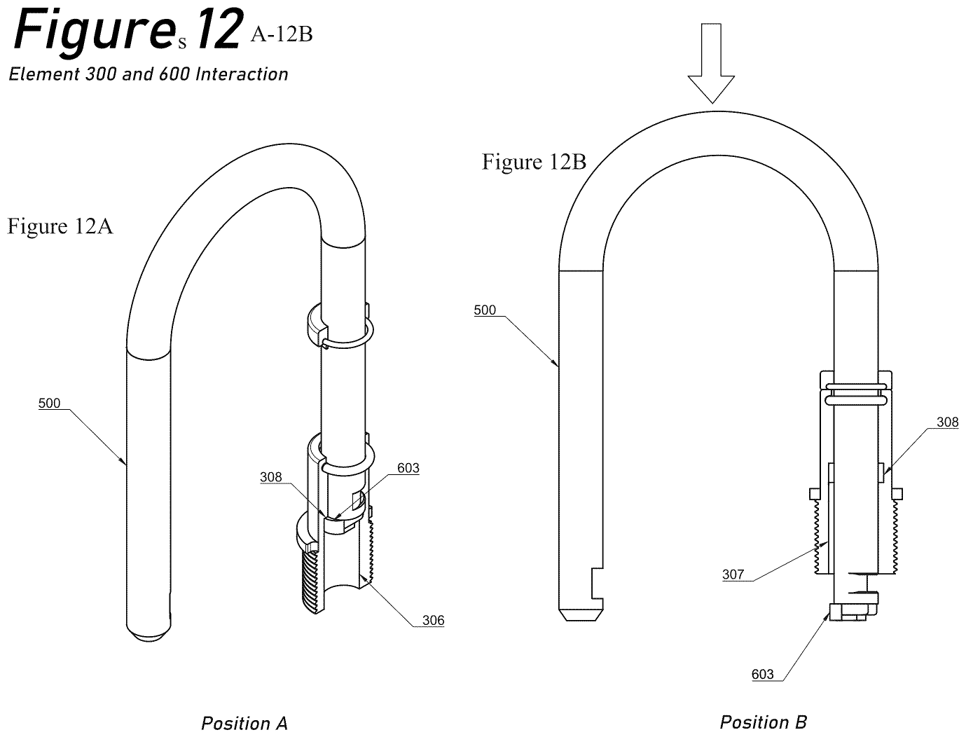

The right side, opposite to the previous one, likewise can have a semicircular shape 603, which can protrude outside the cylinder diameter of shackle 500, achieving a projection that functions as a stop, so that the shackle cannot come out of shackle base 300 where it is contained or otherwise secured. This is accomplished through the movement of shackle 500. At the achieved at the end of the shackle's travel, once it slides towards the open position of the padlock, through the hole 306 and the hole 307 of shackle base 300, until the stop 603 of the shackle lock enters the roughing 308 and, in that position, since hole 307 is not extended, stop 603 abuts and remains contained within shackle base 300. Additionally, the bearing 308 allows the rotary movement of shackle 500 on its own axis, when it is in the open position, so that it can rotate freely to facilitate the placement of the padlock (See FIGS. 12A and 12B)

Sealing Nut 700 is best seen in FIG. 36 where portions thereof are called out by reference numbers 701 to 702. Sealing Nut 700 can be set on the threaded surface 108 of body 100, limiting a Latch Housing 800 within its working range. The center of sealing nut 700 can have a cylindrical hole 701 through which a cylinder portion 801 of Latch Housing 800 can move. Additionally, sealing nut 700 can be provided with two small holes 702 on the outer face that allow the insertion of a tool to enable its screwing.

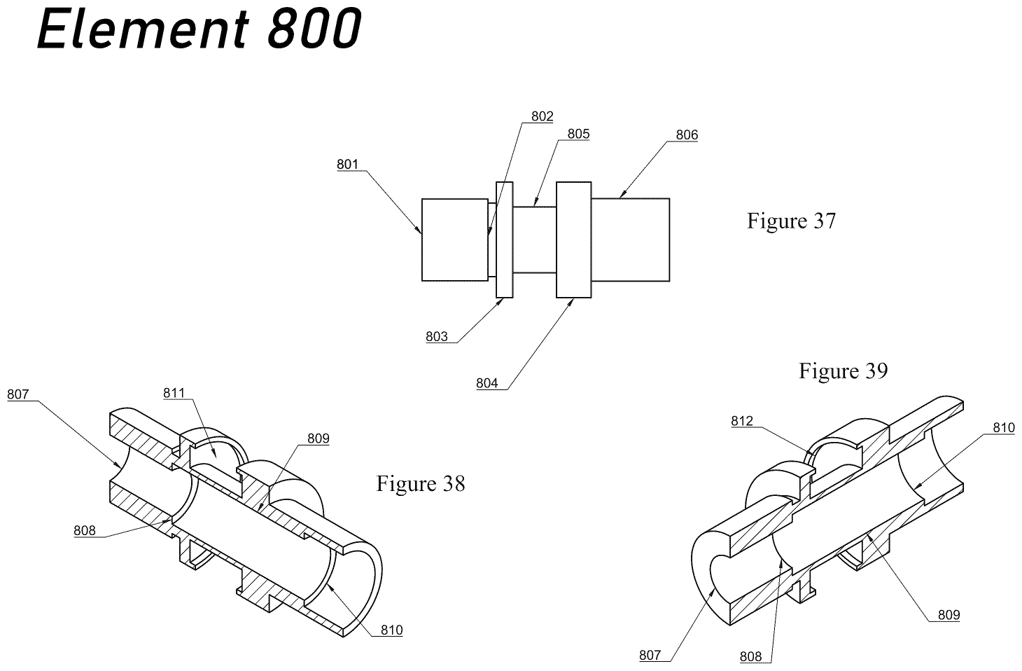

Latch Housing 800 is best seen in FIGS. 37 through 39, where portions thereof are called out by reference numbers 801 to 810.

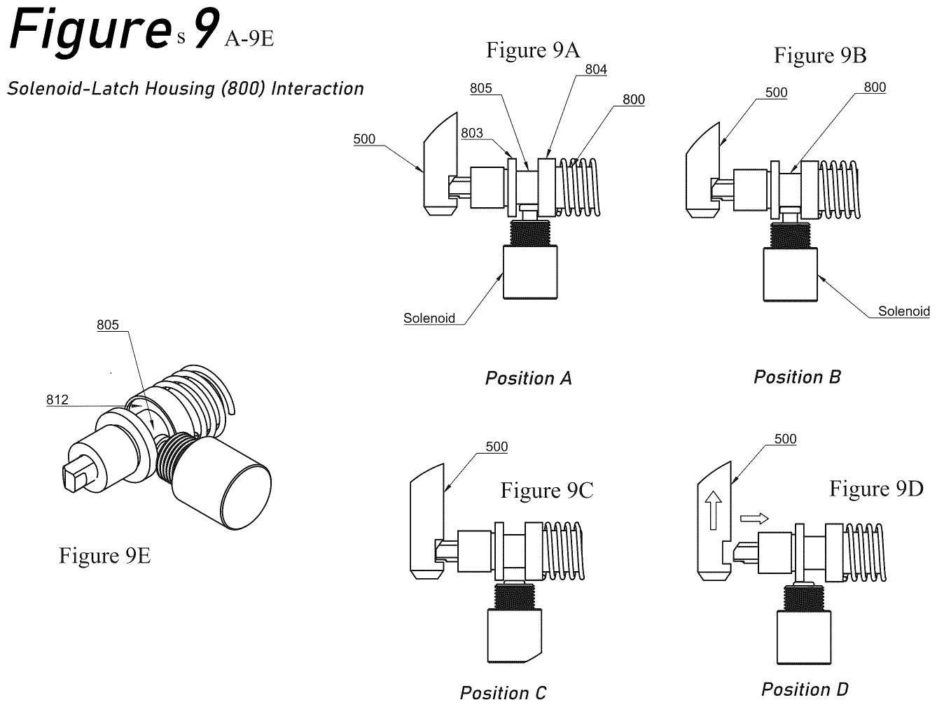

From left to right, Latch Housing 800 can have as a cylindrical surface 801 that slides through Sealing Nut 700 and can have a groove 802 that can house or receive an O-Ring to prevent water from entering the chamber 108 of body 100. Surfaces 803 and 804 can slide on surface 109 of lock body 100. Between these two areas there is a surface 805 where a Solenoid actuator can enter (see FIGS. 9A-9E), blocking the entire mechanism. Finally, a spring can be provided and is guided across surface 806, pressing Latch Housing 800 against button 1400.

The inner surfaces, 807 and 809 can have differing inner diameter dimensions (to create internal steps or stops) and can guide left latch 1000 with 1001 and 1005 as corresponding contact surfaces. Surface 808 (acts as step) limits the movement of left latch 1000, blocking left latch 1000 from being released. On the right side area 810 is provided and contains an internal stop for latch housing (900), preventing its exit through this end.

Between internal walls of members 803 and 804 where the solenoid actuator enters, two slots 811 and 812 (See FIGS. 38 and 39) can be provided for securing and blocking the head of the solenoid actuator entering the slots. (See FIGS. 4A-$d and FIGS. 9A-9E)

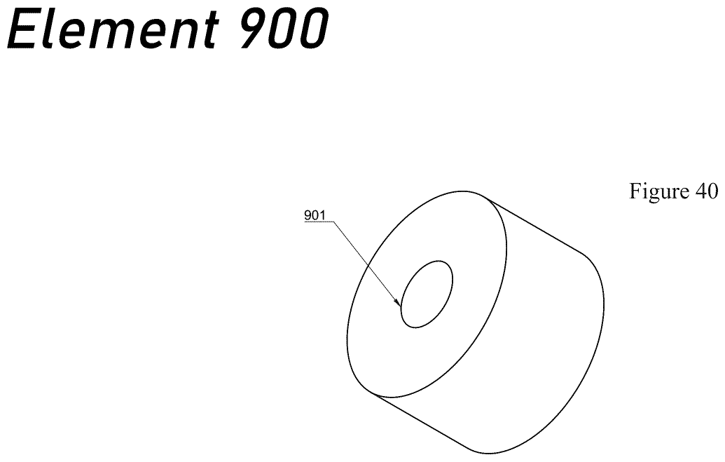

Latch Housing Set Screw 900 is best seen in FIG. 40, where a portion thereof is called out by reference number 901. Latch Housing Set Screw 900 can be placed on the right side of latch housing 800, to prevent left latch 1000 and the spring that interacts with it from coming out. Latch Housing Set Screw 90 can have a center hole 901 to allow part 1102 of the right latch 1100 to slide, while attached to left latch 1000.

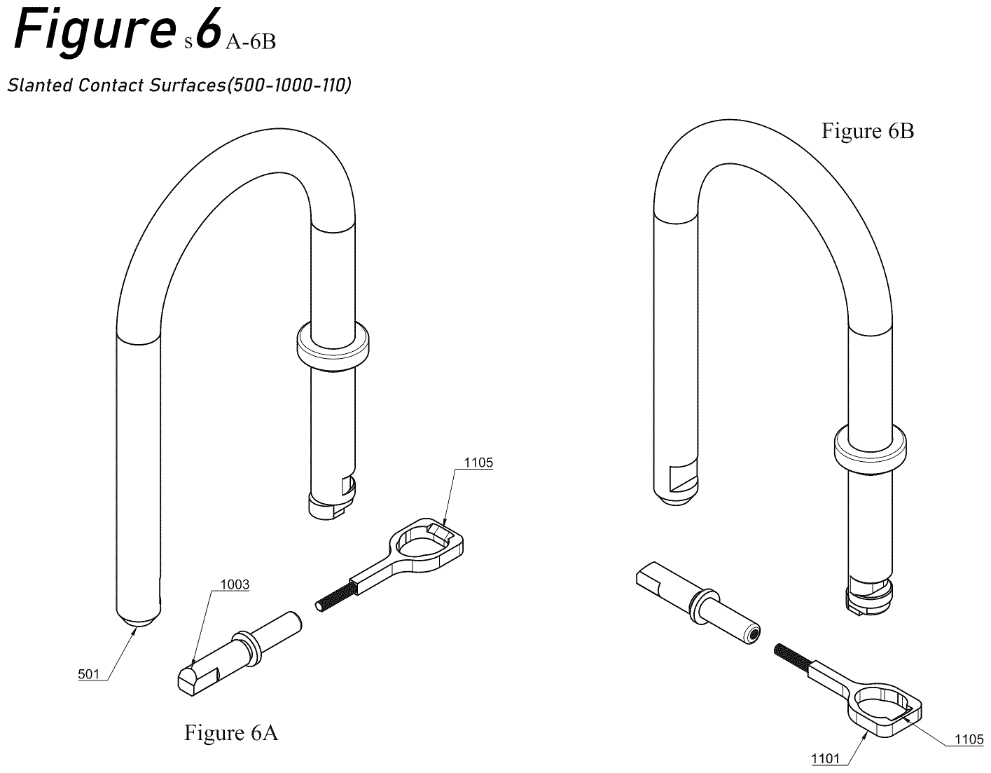

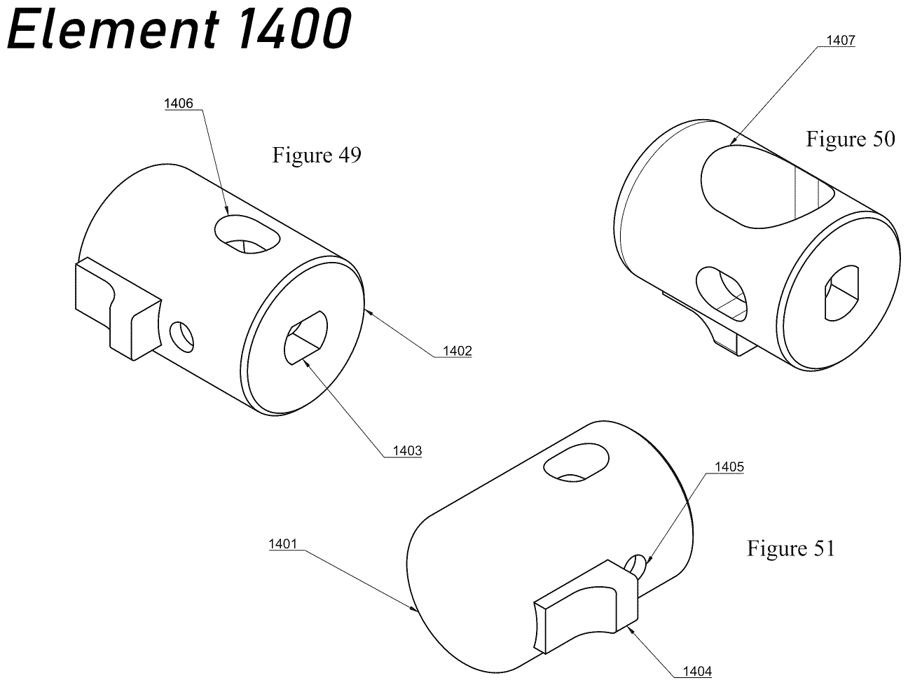

Left Latch 1000 is best seen in FIGS. 41 and 42, where portions thereof are called out by reference numbers 1001 to 1007. Left Latch 1000 can be provided for securing the shackle 500 and in turn, the padlock's closing/locking. Left latch 1000 can move inside Latch Housing 800: Surface/section 1001 can slide through surface 807 and surface/section 1005, through surface 809. Section 1001 can have two milled surfaces 1002 at the tip, which avoid the rotation of Left Latch 10000 when inserted into hole 1403 of the button 1400 (See FIG. 49). The restricted movement of left latch 1000 can ensure the alignment of the surface 1003 which interacts with the shackle 500, allowing the locking of the padlock. (See FIGS. 4A-4D and FIGS. 6A-6B).

A ridge/groove 1004 can houses or receive the Left Latch's O-Ring to aid in waterproofing the mechanism. Around cylinder 1006, the Latch Spring is placed. (See FIGS. 4A=4D) The threaded internal hole 1007 allows the joining of Left Latch 1000 with a Right Latch 1100.

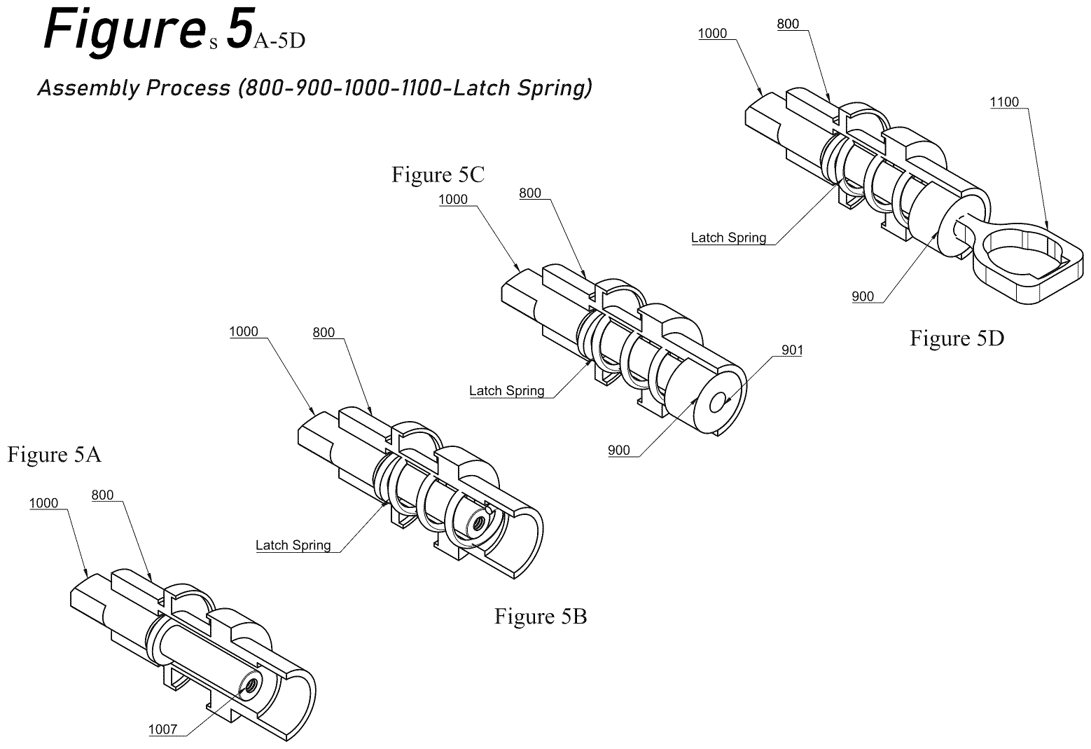

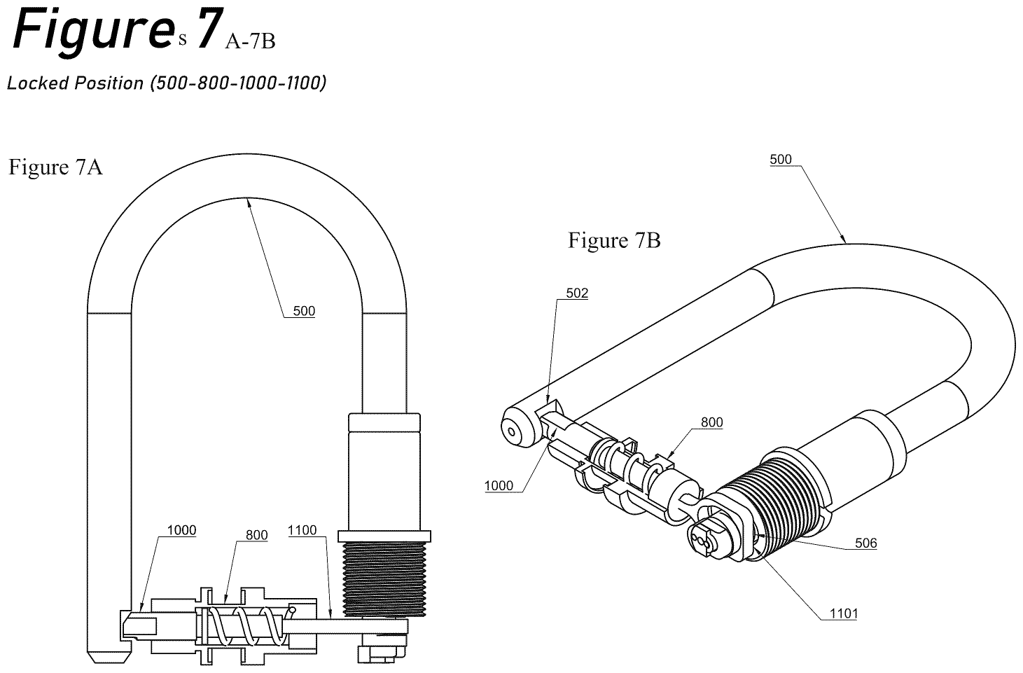

Right Latch 1100 is best seen in FIGS. 43 and 44, where portions thereof are called out by reference numbers 1101 to 1105. Right Latch 1100 can preferably comprise two sections: an extruded profile (1101) and a cylinder (1102). The profile can slide on channel 115 of the body 100. Profile 1101 can have hole in the middle to allow the passing of the right or second end of shackle 500. Thus, hole 1104 provides clearance for a portion of shackle 500 to be inserted therethrough (See FIG. 7B). In the interior perimeter of hole 1104, a beveled edge/ledge 1105 can be provided to aid in the entry of the Shackle 500 (See FIGS. 4A-4D and FIGS. 6A-6B). This section can also block shackle 5000, fulfilling a latch's function, when in contact with feature 506 of the Shackle. (See FIGS. 4A-4D and FIG. 7B). At the end of the cylinder or section 1102 a threaded section 1103 can be provided that can be screwed into hole 1007 of Left Latch 1000 for joining, securing or attaching left latch 100 with right latch 1100. (See FIG. 5D).

Cable Wire Rope 1200 is best seen in FIGS. 45 and 46, where portions thereof are called out by reference numbers 1201 to 1210 and can be used in an alternative embodiment for the novel portable padlock in lieu of shackle 500 Cable wire rope 1200 is preferably used in connection with alternative body embodiment 100A. Though not limiting, preferably cable wire rope 1200 can include a stainless steel Cable Wire Rope 1201 which be clamped inside, or otherwise secured to, stainless-steel fittings 1202 and 1203 and having an electrical wire looped inside (for similar purposes as the continuity cable/wire running through shackle 500). The electrical wire loop's crest can be located on a left end of cable wire rope 1200 and the two ends of the electrical wire can exit cable wire rope 12000 through hole 1204 on the right side, where the two ends can pass by hole 116 of the body 100A and enter the inner chamber of the padlock, where the electronics are preferably housed.

Threaded surface 1205 allows screwing the right end of cable wire rope 1200 into hole 112A of the body 100A. Feature or flange 1206 acts as an indicator as to how deep cable wire rope 1200 should be screwed in (i.e. when flange 1206 meets the base of hole 126 on body 100A). This fixed depth can allow portion 1207 to be aligned with hole 115A on body 100A, where the Right Fitting Set Screw is placed, preventing removal.

The left side can end in a conical shape 1208 that can match or correspond to Left Latch 1000 pushing it sideways to allow the entry of Cable Wire Rope 1200 to the padlock's Body 100A. At the tip's end a hole 1209 can be provide that houses or received a Cable Wire Rope Magnet, that interacts with the sensor placed in the Sensor Support. Above the cone-shaped tip, a slot or groove 1210 can be provided into which Left Latch 1000 can enter, locking Cable Wire Rope 1200.

Left or First Fitting Accessory 1300 is best seen in FIGS. 47 and 48, where portions thereof are called out by reference numbers 1301 to 1304. Accessory 1300 can provide additional length to the guided trajectory of the Left Fitting entry, restricting the movement to a uniaxial one, as the latter slides through internal surface 1302. Cylinder 1303 can enter hole 106 of body 100A. Blank or member 1304 allows a grub screw to enter that slot from the body of the lock, for the purpose of securing accessory 1300.

Button 1400 is best seen in FIGS. 49 through 51, where portions thereof are called out by reference numbers 1401 to 1407. Button 1400 can be generally cylindrical shaped that moves alongside hole/passageway 101 of the padlock body 100. Button 1400 primary function is to contribute to the opening of the novel portable padlock. An outer wall 1401 preferably is where the user's finger pushes button 1400 towards the inside of hole/passageway 101 where button 1400 is housed by body 100, and making surface 1402 displace Latch Housing 800 along with the; et latch 1000 and right latch 1100 for releasing the shackle 500 (i.e. opening of the novel portable padlock).

Hole 1403 allows the tip of Left Latch 1000 to pass through. This adds length to the guided trajectory of Left Latch 10000, reducing the load on the material, as well as avoiding bending and misalignment of the parts.

A generally rectangular block/member 1404 can be attached to the outer surface, to secure the top 200 so that it cannot be removed once the padlock is closed. The shallow slot 202 of one of the anchoring posta 201 of top 200 is where block 1404 performs the function of a latch. Next to the block 1404 a hole (1405) can be provided so that button 1400 does not obstruct the path between the Shackle Magnet and magnetic sensor.

Preferably, generally perpendicular to block 1404, a slot shaped hole 1406 can be provided for the Button Screw to impede the separation between button 1400 and Body 100. Slot 1407 (FIG. 50) can ensure that there is no interference between button 1400 and the left end of shackle 500, for both components to work independently.

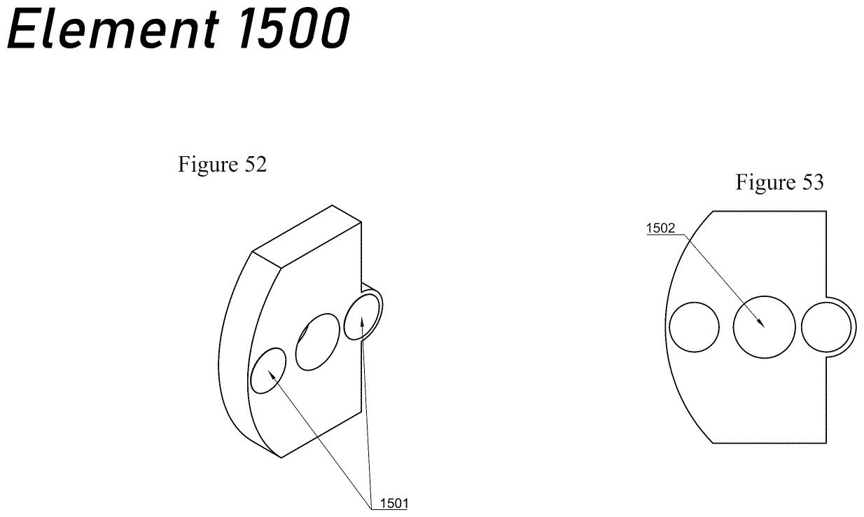

Shackle Opening and Cutting Sensor 1500 is best seen in FIGS. 52 and 53, where portions thereof are called out by reference numbers 1501 to 1504. Sensor 1500 can be a printed circuit board that can be placed on the upper surface of the shackle lock (600), fixing between the center of the crescent 501 of shackle 500 and a stop that, to contain it, shackle lock 603 in its leftmost is provided.

The printed circuit board has two circular copper tracks 1501 on its surface, which can make contact with two switches placed on body 100 of the lock, connected to the electronic board of the lock with the purpose of having two signals, which the padlock electronics microcontroller will process:
1. The first signal can measure the continuity of the shackle cut sensor. It can be a two-wire cable, which passes inside the central hole that passes through shackle 500 along its entire length 506. The two wires of the cable can be soldered to each of the two copper tracks 1501 that the board has. When the closing arch (shackle 500) is in the closed/locked position, the two contacts 1501 on the plate in turn make contact with the switches placed inside body 100 of the padlock, creating a closed circuit (See FIGS. 13A and 13B). When the closing arc is cut, one or both wires of the cable are also cut, so continuity is interrupted, and the microcontroller of the electronic card interprets this signal, which can issue a cut alarm to the tracking platform software.
2 The second signal has to do with the opening of shackle 500, with the two switches placed on body 100 of the padlock. When shackle 500 opens, contact with the switches on the plate is stop/discontinued/disrupted, with the electronics of the padlock interpreting the signal generated as an opening of the padlock.

A center hole 1502 can be provided and allows the passage of the two-wire cable coming from shackle 500, which can be soldered to each of the copper tracks of the printed circuit board.

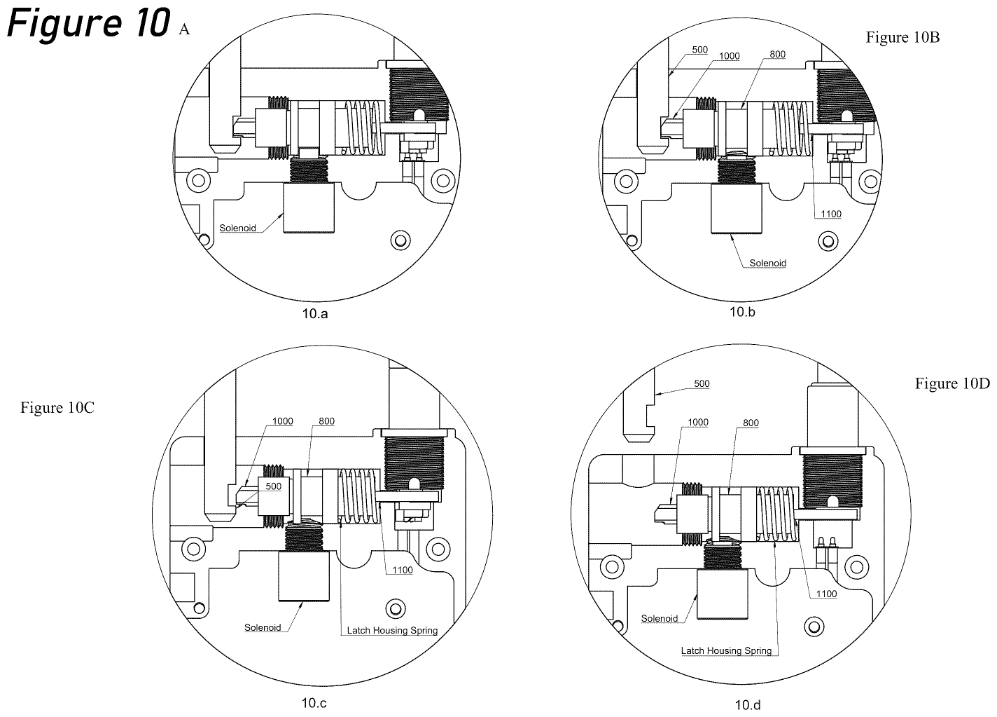

Some additional parts/components for the novel portable padlock can include, without limitation, the following:
a. Keypad (FIGS. 1 and 1A)—preferably located in hollowed surface/area 207 of top 200 and can be secured with screws (i.e. such as, 10 screws/holes—though not limiting) through holes 208 provided in top 200;
b. Keypad Seal—preferably located in hollowed surface/area 207 of top 200 and can be placed between the top 200 and the Keypad, to aid in waterproofing the chamber that houses the electronics within the padlock;
c. Top Seal—preferably located in cavity 205 of top 200 and can be pressed in place by ridge/protrusion 122 of body 100. The top seal can aid in waterproofing the chamber that houses the electronics within the padlock;
d. Screw Covers—to avoid or reduce the Shackle Base Screw and the Button Screw from being removed, covers can be bolted or otherwise secured/disposed in place;
e. Shackle Base Screw—To prevent or reduce the unscrewing of Shackle Base 300, a screw can be passed through hole 118 of the Body 100 and slot 304 of Shackle Base 300;
f. Button Screw—To prevent or reduce button 1400 from separating from the lock, a screw cam be passed through hole 105 of the body 100 and slot 1406 of Button 1400;
g. Shackle Base O-Ring—Preferably placed on Shackle Base 300 and pressed by surface/portion 402 of Shackle base cover 400. This o-ring helps to prevent water from entering the internal chambers of shackle 500 and the padlock;
h. Shackle Base Cover O-Ring—Preferably placed in slot 403 of the Shackle Base Cover (400). When padlock shackle 500 is closed/locked, this O-ring can be pressed against stop 310 of the shackle base 300, to help prevent water from entering the internal chambers of the padlock;
i. Sensor Support—Preferably placed in cylindrical hole 104 of body 100, it houses the magnetic sensor that interacts with the Shackle Magnet placed on left end 503 of the shackle 500;
j. Left Latch O-Ring—Ridge/groove 1004 of the Left Latch 1000 houses/receives a Left Latch O-Ring to aid in waterproofing the mechanism;
k. Latch Housing O-Ring—Preferably placed on the ridge/groove 802 of Latch Housing 800 to help prevent water from entering past chamber 108 of body 100;
l. Solenoid—Can be fixed on body 100 in hole 110 and is provided for locking and releasing Latch Housing 800 (See FIGS. 4A-4D, FIGS. 10A-10D and FIGS. 11A-11B);
m. Latch Housing Spring—The Latch Housing Spring can be guided or disposed along by surface portion 806 of Latch Housing 800, for propelling latch housing 800 towards Button 1400, to aid in the locking/unlocking mechanism of the novel portable padlock (See FIGS. 10A-10D);
n. Latch Spring—Preferably placed around the cylinder 1006 of Left Latch 1000 and allows for the locking of the mechanism. (See FIGS. 4A-4D);
o. Shackle Magnet—Preferably placed on hole 505 in the left end of Shackle 500 for interacting with a magnetic sensor;
p. Body Magnet—For fixing the padlock on metal surfaces. The body magnet can be secured in place with a Body Magnet Screw;
q. Cable Wire Rope Magnet—Preferably placed on hole 1209 in Cable Wire Rope 1200 for interacting with a magnetic sensor; and
r. Right accessory fixing screw—prevent or reduces metal cable 1200 from unscrewing. The screw enters body 100A through hole 118 of the Body.

FIG. 1 shows a preferred exploded view for one non-limiting embodiment with parts listed with their corresponding code. FIG. 1A shows a preferred exploded view for another non-limiting embodiment with parts listed with their corresponding code.

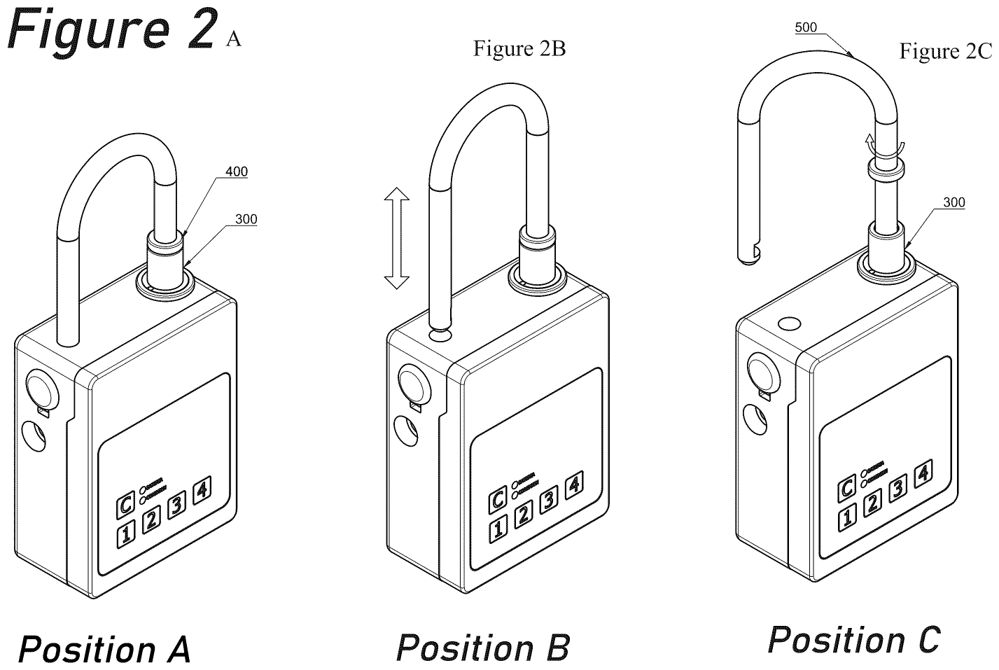

FIGS. 2A-2C illustrate placing shackle 500 in position. The right end of shackle 500 can be anchored/secured inside body 100, via a shackle base 300. The support from shackle base 300 allows the shackle's movement in an up and down motion (FIG. 2B), as well the rotation of shackle 500 on an axis along the right side (FIG. 2C). This combination of motions makes it possible to introduce the free end of shackle 500 on the element to be protected (i.e. shipping container, locker, box, etc.). Once shackle 500 is interlocked with the desired element, the free end is aligned in the direction of an entry hole 106 in the upper part of padlock body 100. In this position, the free end is pushed into body 100 through hole 106, which also blocks rotation of the shackle (FIG. 2A).

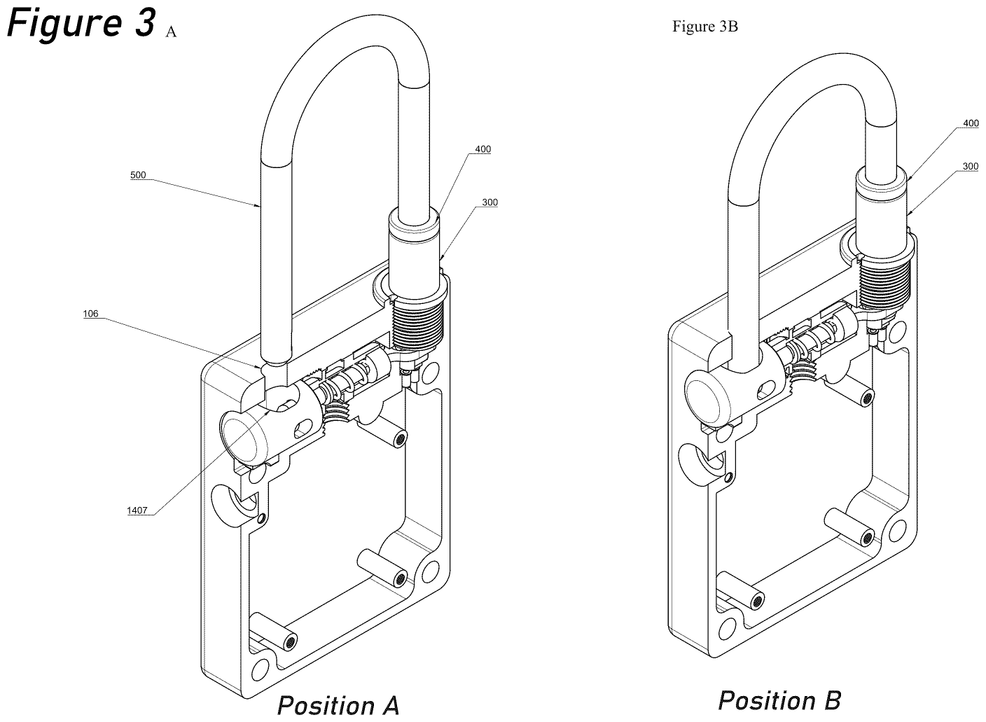

FIGS. 3A and 3B show the interaction between shackle 500 and button 1400. When closing the padlock, (from Position A—FIG. 3A to Position B—FIG. 3B) the tip of one end of shackle 500 can go through slot 1407 on the top of the Button 1400. Preferably, there is no interference between the parts at any point of the operations.

FIGS. 4A-4D illustrate the locking mechanism. In FIG. 4A, shackle 500 enters body 100. In FIG. 4B the conic tip 501 on the left end of shackle 500 meets the slanted surface 1003 of left latch 1000, as the conic surface on the right meets the slanted surface on the right latch 1100 (not visible in FIGS. 4A-$D—but see FIGS. 6A and 6B). With left latch 1000 and right latch 1100 joined together, both contacts push the joined contraption in one direction (i.e. to the right, etc.), enough for shackle to continue its entry within body 100. In FIG. 4C, the Latch Spring pushes the Left Latch-Right Latch joined contraption in the opposite direction (i.e. to the left, etc.) as shackle 500 moves further inside body 100. In FIG. 4D, when portions/features 502 and 506 of shackle 500 are aligned with the latches, these two latches (1000 and 1100) fulfill their purpose and the end of left latch 1000 is contained/disposed within slot 502 of shackle 500.

FIGS. 5A-5D illustrated the assembly process for the latching housing 800, latch housing set screw 900, left latch 1000, right latch 1100 and Latch Spring. Initially, Left Latch 1000 can be introduced inside Latch Housing 800 through the right end of left latch 1000, then the Latch Spring followed by the Latch Housing Set Screw 900 and finally, the Right Latch 1100 is screwed inside the Left Latch via the 1007 hole of left latch 1000, going through hole 902 of set screw 900..

FIGS. 6A and 6B illustrate the slanted contact surfaces for shackle 500, left latch 1000 and right latch 1100. The conic surfaces that come into contact between the shackle 500 and the two latches 1000 and 1100 are seen to further explain the translation of movement from one direction to a perpendicular one.

FIGS. 7A and 7B illustrate a locked position between shackle 500, latch housing 800, left latch 1000 and right latch 1100. Two blocking points that the joined latches contraption exert on shackle 500 are seen, which are, the outer end of left latch 1000 disposed within slot 502 of shackle 500, and the relationship between member 1101 of right latch 1100 and member 506 of shackle 500.

FIGS. 8A and 8B illustrate additional blockage between top 200 and button 1400. The rectangular-shaped part 1404 of the button 1400 can perform the function of a latch when interfering with the shallow slot 202 in one of the anchoring posts 201 of top 200 as shown in Position A—FIG. 8A. When the padlock is opened, button 1400 is pushed towards the inside of the body 100 and the interference is eliminated to allow top 200 to be separated from body 100 as shown in Position B—FIG. 8B.

FIGS. 9A-9E illustrate the interaction between the solenoid and latch housing 800. Position A—FIG. 9A shows the rest position of the Solenoid. The solenoid actuator blocks the movement of Latch housing 800 upon entering into groove/feature 805 (located between portions 803 and 804. In addition, the head of the solenoid actuator enters a into slot 812 (present in portion 804) (See FIG. 9E), which in turn blocks the neck of the actuator, preventing it from being retracted into the solenoid. The actuator remains locked in that position as a result of the force exerted by the box spring to the left, in the axis transverse to the movement of the actuator.

Position B—FIG. 9B: When the lock is to be opened, a signal is sent to the solenoid, this electromechanical component tries to retract its actuator, which needs to be released from the previous position. To release it, padlock button 1400 is pressed, which in turn pushes the latch housing to the right, releasing the solenoid head from slot 812.

Position C—FIG. 9C—Once the head of the solenoid actuator is unlocked, it can be retracted inwards, which unlocks the advancement of latch housing 800 on the axis transverse to shackle 500.

Position D—FIG. 9D: When the latch advance is unlocked, it moves to the right as a result of the force exerted by button 1400) This action jointly displaces the latch 1000 housed inside the box (slot 502 of shackle 500, which releases shackle 500 and allows the associated leg/side of shackle to be lifted out of body 100 to open the padlock.

FIGS. 10A-10D illustrate the unlocking Mechanism. In FIG. 10A—The Solenoid's tip retracts when the electromechanics component of the solenoid receives an electric signal, moving from the top configuration to the bottom. In FIG. 10B—Button 1400 is pushed inwards by the operator. In FIG. 10C—The Latch Housing Spring is compressed when button 1400 is pressed against Latch Housing 800 until both latches (1000 and 1100) release the shackle 500. In FIG. 10D—when portions/feature 502 and 506 of shackle 500 are no longer obstructed by the latches, it is possible to open the padlock.

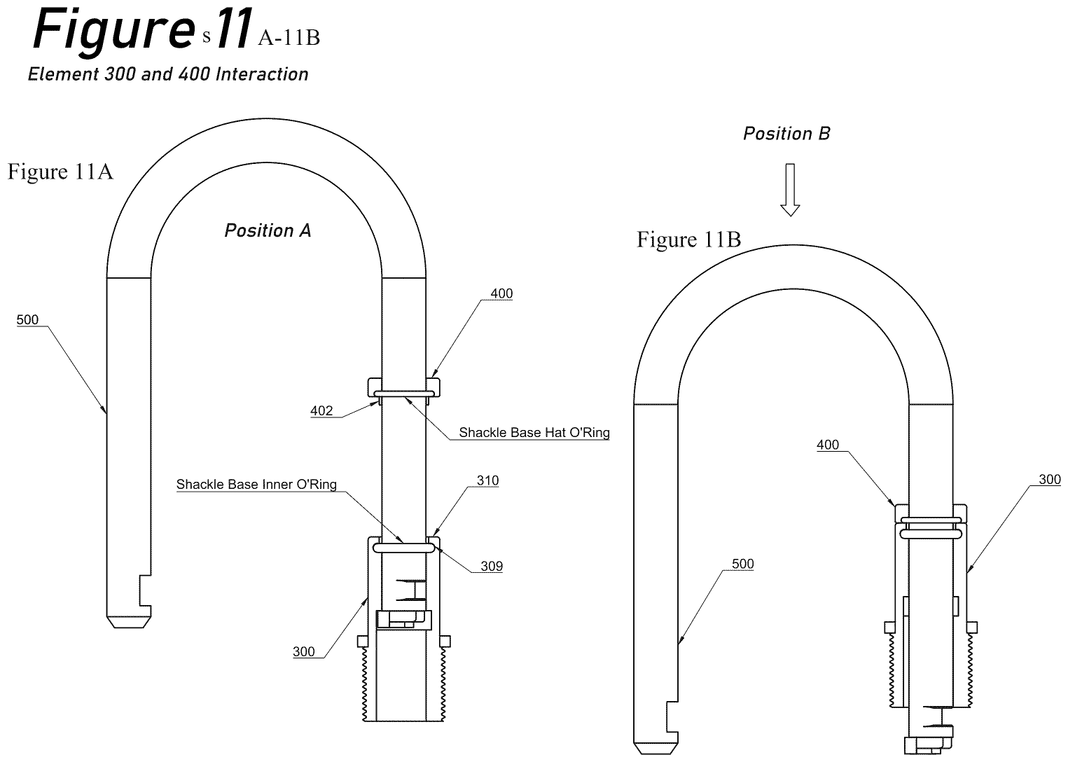

FIGS. 11A and 11B illustrate interaction between shackle base 300 and shackle base cover (400). This interaction allows the central hole at the base of shackle 500 to be sealed to prevent water and other elements from entering the central compartment that houses the electronics in body 100. Cover 400 can be provided with an O-ring housed within its body, as indicated in position A (FIG. 11A) of shackle 500. When shackle 500 is closed in position B (FIG. 11B), cover 4000 can be welded or otherwise secured (i.e. preferably permanently—though not limiting) to shackle 500 and moves together towards shackle base 300 and the O-ring presses its stop 310 helping to seal once shackle 500 is secured in its closed position.

Additionally, when shackle 500 is in its “closed” position (FIG. 11B—Position B), the ring of cover 400 has at its base 402 can have a diameter that penetrates and presses the central area of the O-ring housed in shackle base 300, ensuring that expands into area 309, which seals that space against the penetration of water and other elements.

FIGS. 12A-12B illustrate the interaction between shackle base 300 and shackle stop/lock 600. The interaction can regulate the travel of shackle 500, to a certain position when it opens, and to prevent it from leaving shackle base 300 that contains it. Additionally, once shackle 500 reaches its opening position, it can rotate 360 degrees on its axis, to facilitate the removal or placement of the padlock. Shackle lock 600 has a stop 603 that protrudes from the diameter of shackle 500 and moves inside a cavity 307 of shackle base 300, which can run parallel to a central hole 306 of shackle base 300). The size of the cavity restricts the travel of shackle lock 500, until it enters a cylindrical slot 308, along the entire internal diameter of shackle base 300, allowing shackle 500 to rotate 360 degrees in that position.

FIGS. 13A and 13B illustrate an interaction between the shackle opening or cutting sensor 1500 and the switches placed in body 100. The shackle opening and cutting sensor 1500 can be placed and fixed at the base of the shackle lock, is connected to the two-wire continuity cable, which runs its entire length internally through the central conduit of shackle 500. Each wire of the cable can be soldered to the corresponding track of two contacts 1501 on the printed circuit board that forms the opening and closing sensor 1500. On the other hand, two switches are placed within body 100 in a position/location aligned with each of the tracks of the cutting and separation sensor 1500. When shackle 500 is in position A (FIG. 13A), the two sensor tracks do not have contact with the switches in body 100 (which are connected to the padlock control electronics), so it is interpreted that shackle 500 is open. When shackle 500 moves towards position B (FIG. 13B), it moves together with the opening and continuity sensor 1500 placed at its end, where its tracks (1501), are aligned with the switches, make contact, closing the circuit, so the Control electronics assume that the shackle is in closed position B. In the circuit closed position, if shackle 500 is cut, the wires of the cable inside are also cut, interrupting continuity, which allows the control electronics to issue an alarm signal due to cutting of shackle 500.

Description of Lock Mechanism's Parts for one non-limiting embodiment:
1—Body (100). From 101 to 125 1A—Body (100A). From 101 to 125
2—Top (200). From 201 to 208
3—Shackle Base (300). From 301 to 307
4—Shackle Base Cover (400). From 401 to 403
5—Shackle (500). From 501 to 506
6—Shackle lock (600). From 601 to 603
7—Sealing Nut (700). From 701 to 702
8—Latch Housing (800). From 801 to 810
9—Latch Housing Set Screw (900).
10—Left Latch (1000). From 1001 to 1007
11—Right Latch (1100). From 1101 to 1105
12—Cable Wire Rope (1200). From 1201 to 1209
13—Left Fitting Accessory (1300). From 1301 to 1303
14—Button (1400). From 1401 to 1407
15—Shackle opening and cutting sensor (1500). From 1501 to 1504

It should be understood that the exemplary embodiments described herein should be considered in a descriptive sense only and not for purposes of limitation. Descriptions and operation of features, components, parts or aspects within each embodiment should typically be considered as available and applicable to other similar features, components, parts or aspects in 15 other embodiments and are considered incorporated by reference as if fully set forth therein for the description of the other embodiment(s). While one or more embodiments have been described with reference to the figures, it will be understood by those of ordinary skill in the art that various changes in form and details may be made therein without departing from their spirit and scope.

Dimensions of certain parts as shown in the drawings may have been modified and/or exaggerated for the purpose of clarity of illustration and are not considered limiting.

All measurements, amounts, sizes, shapes, configurations, locking mechanisms, electronic circuitry and components, securement or attachment mechanisms, sensing members, communication and electronic communication methods, sealing members, numbers, ranges, frequencies, values, percentages, materials, orientations, methods of manufacture, etc. discussed above or shown in the drawing figures are merely by way of example and are not considered limiting and other measurements, amounts, sizes, shapes, configurations, locking mechanisms, electronic circuitry and components, securement or attachment mechanisms, sensing members, communication and electronic communication methods; sealing members, numbers, ranges, frequencies, values, percentages, materials, orientations, methods of manufacture, etc. can be chosen and used and all are considered within the scope of the invention.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim when and if the claim element, claim step or claim term is interpreted or construed. Similarly, with respect to any “means for” elements in the claims, the inventor considers such language to require only the minimal number of features, components, steps, or parts from the specification to achieve the function of the “means for” language and not all of the features, components, steps or parts describe in the specification that are related to the function of the “means for” language.

The benefits, advantages, solutions to problems, and any element(s) that may cause any benefit, advantage, or solution to occur or become more pronounced are not to be construed as a critical, required, or essential features or elements of any or all the claims.

While the disclosure has been described in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A portable padlock operable in outdoor environments and opened electronically, comprising:
a housing;
control electronics stored within the housing; the control electronics having wireless connectivity capabilities to allow the control electronics to receive control commands or signals from remotely located sources;
a power source stored within the housing, the power source powering the control electronics;
a shackle or a cable wire rope having a first end secured to the housing and a second end removably secured to the housing such that when the second end is not secured to the housing the padlock is in an open position and when the second end is secured to the housing the padlock is in a closed position;
a solenoid in communication with the control electronics and retractable or extendable based on signals received from the control electronics for opening or closing the padlock.

2. The portable padlock of claim 1 further comprising a touch keyboard secured to the housing in an externally accessible position, the touch keyboard in communication with the integrated control electronics to allow the portable padlock to be opened with a passkey in places where remote unlocking is not possible.

3. The portable padlock of claim 1 wherein the power source is one or more rechargeable batteries and the portable padlock further comprising one or more solar panels for recharging the one or more rechargeable batteries in place.

4. The portable padlock of claim 1 wherein the housing is waterproof.

5. The portable padlock of claim 1 further comprising one or more sensors in communication with the control electronics, the sensors providing information to the control electronics when the portable padlock is opened, locked or cut.

6. The portable padlock of claim 1 further comprising an APP configured to manage various functionalities of the portable padlock through wireless communication between an electronic device running the APP and the control electronics for remote opening or locking of the portable padlock where internet connectivity is present.

7. The portable padlock of claim 1 further comprising a shackle base secured to the housing, wherein the first end of the shackle is secured to the shackle base.

8. The portable padlock of claim 7 wherein when the shackle is in an open position the shackle can be rotated 360 degrees around securement point of the first end of the shackle to the shackle base.

9. The portable padlock of claim 7 further comprising a printed circuit board having sensor tracks/contacts disposed at a tip area of the first end of the shackle and a pair of switches disposed within the housing that are in electrical communication with the control electronics; wherein when the padlock is in a closed position the first end of the shackle is disposed further within the shackle base to allow the sensor tracks/contacts to contact or make electrical communication with the pair of switches causing the control electronics to be informed that the padlock is in a closed position; wherein in a padlock open position no physical or electrical contact or communication is made between the switches and the sensor tracks/contacts.

10. The portable padlock of claim 9 further comprising a continuity wire disposed internally within the shackle and in electrical communication with the sensor tracks/contacts; wherein when the padlock is in a closed position in an event where the shackle is cut the continuity wire is also cut causing a signal previously sent indicating that the padlock was closed to be discontinued.

11. The portable padlock of claim 10 wherein the continuity wire runs from the first end of the shackle to the second end of the shackle.
